(19) United States
(12) Patent Application Publication
(10) Pub. No.: US 2026/0014469 A1
(43) Pub. Date: Jan. 15, 2026

(54) VIRTUAL VEHICLE CONTROL

(71) Applicant: TENCENT TECHNOLOGY (SHENZHEN) COMPANY LIMITED, Shenzhen (CN)

(72) Inventor: Ziyi WANG, Shenzhen (CN)

(73) Assignee: TENCENT TECHNOLOGY (SHENZHEN) COMPANY LIMITED, Shenzhen (CN)

(21) Appl. No.: 19/330,081

(22) Filed: Sep. 16, 2025

Related U.S. Application Data
(63) Continuation of application No. PCT/CN2025/070637, filed on Jan. 6, 2025.

(30) Foreign Application Priority Data
Jan. 26, 2024 (CN) 202410124822.4

(51) Int. Cl. A63F 13/56; A63F 13/533; A63F 13/803

(52) U.S. Cl. CPC A63F 13/56; A63F 13/533; A63F 13/803

(57) ABSTRACT

In a virtual vehicle control method, a virtual vehicle driven by a virtual character and at least one control element is output for display. An operation performed on a control element of the at least one control element is determined. Based on the operation being performed on the control element, the virtual character is controlled to separate from the virtual vehicle in a first safe state when the control element is of a separation control type, and the virtual character is controlled to continue driving the virtual vehicle in a second safe state when the control element is of a driving control type.

### RELATED APPLICATIONS

The present application is a continuation of International Application No. PCT/CN2025/070637, filed on Jan. 6, 2025, which claims priority to Chinese Patent Application No. 202410124822.4, filed on Jan. 26, 2024. The entire disclosures of the prior applications are hereby incorporated by reference.

### FIELD OF THE TECHNOLOGY

This application relates to the field of game technologies, including a virtual vehicle control technology.

### BACKGROUND OF THE DISCLOSURE

In a control scene for a virtual vehicle, insufficient control accuracy for the virtual vehicle often leads to incidents such as overturning or even destruction of the virtual vehicle. The overturning is particularly prone to occur when the virtual vehicle is traveling at a high speed. This may cause harm to a virtual character driving or riding in the virtual vehicle.

Currently, no effective solution has been proposed to resolve a problem of low control accuracy for the virtual vehicle.

### SUMMARY

Aspects of this disclosure provide a virtual vehicle control method, a virtual vehicle control apparatus, and a non-transitory computer-readable storage medium to improve control accuracy for a virtual vehicle. Examples of technical solutions of this disclosure may be implemented as follows:

An aspect of this disclosure provides a virtual vehicle control method. In the method, a virtual vehicle driven by a virtual character and at least one control element is output for display. An operation performed on a control element of the at least one control element is determined. Based on the operation being performed on the control element, the virtual character is controlled to separate from the virtual vehicle in a first safe state when the control element is of a separation control type, and the virtual character is controlled to continue driving the virtual vehicle in a second safe state when the control element is of a driving control type.

An aspect of this disclosure provides a virtual vehicle control apparatus. The apparatus includes processing circuitry configured to output for display a virtual vehicle driven by a virtual character and at least one control element. The processing circuitry is configured to determine an operation is performed on a control element of the at least one control element. Based on the operation being performed on the control element, the processing circuitry is configured to control the virtual character to separate from the virtual vehicle in a first safe state when the control element is of a separation control type, and the processing circuitry is configured to control the virtual character to continue driving the virtual vehicle in a second safe state when the control element is of a driving control type.

An aspect of this disclosure provides virtual vehicle control method. The method is performed by an electronic device. The method includes: displaying a virtual vehicle driven by a virtual character and an intelligent control element; controlling the virtual character to separate from the virtual vehicle in a safe state in response to an operation triggered based on the intelligent control element in a case that the intelligent control element is of a separation control type; and assisting, by the intelligent control element, in controlling the virtual character to continue driving the virtual vehicle in the safe state in a case that the intelligent control element is of a driving control type.

An aspect of this disclosure provides a virtual vehicle control apparatus. The apparatus includes: a display unit, configured to display a virtual vehicle driven by a virtual character and an intelligent control element; a first control unit, configured to control the virtual character to separate from the virtual vehicle in a safe state in response to an operation triggered based on the intelligent control element in a case that the intelligent control element is of a separation control type; and a second control unit, configured to assist, by the intelligent control element, in controlling the virtual character to continue driving the virtual vehicle in the safe state in a case that the intelligent control element is of a driving control type.

An aspect of this disclosure provides a non-transitory computer-readable storage medium storing instructions which, when executed by a processor, cause the processor to implement the foregoing virtual vehicle control methods.

An aspect of this disclosure provides a computer program product or a computer program. The computer program product or the computer program includes computer instructions. The computer instructions are stored in a computer-readable storage medium. A processor of an electronic device reads the computer instructions from the computer-readable storage medium. The processor executes the computer instructions, to cause the electronic device to perform the foregoing virtual vehicle control methods.

An aspect of this disclosure provides an electronic device, including a memory, a processor, and a computer program stored in the memory and executable on the processor. The processor performs the foregoing virtual vehicle control methods by using the computer program.

In the aspects of this disclosure, a virtual vehicle driven by a virtual character and an intelligent control element are displayed. The virtual character is controlled to separate from the virtual vehicle in a safe state in response to an operation triggered based on the intelligent control element in a case that the intelligent control element is of a separation control type. The intelligent control element assists in controlling the virtual character to continue driving the virtual vehicle in the safe state in a case that the intelligent control element is of a driving control type. An intelligent control element is introduced to assist in controlling a relationship between a virtual character and a virtual vehicle, to improve control accuracy for the virtual character driving the virtual vehicle, thereby avoiding safety accidents such as overturning and destruction. In addition, the virtual character can safely separate from or continue driving the virtual vehicle as necessary, so that even if an operation of a player is not accurate or timely enough, the intelligent control element can be adapted and compensated to some extent, thereby reducing accident risks caused by control errors, achieving a technical effect of improving the control accuracy for the virtual vehicle, and further resolving a technical problem of low control accuracy for the virtual vehicle.

### BRIEF DESCRIPTION OF THE DRAWINGS

FIG. 1 is a schematic diagram of an application environment of a virtual vehicle control method according to an aspect of this disclosure.

FIG. 2 is a schematic flowchart of a virtual vehicle control method according to an aspect of this disclosure.

FIG. 3 is a schematic diagram of a virtual vehicle control method according to an aspect of this disclosure.

FIG. 4 is a schematic diagram of a virtual vehicle control method according to an aspect of this disclosure.

FIG. 5 is a schematic diagram of a virtual vehicle control method according to an aspect of this disclosure.

FIG. 6 is a schematic diagram of a virtual vehicle control method according to an aspect of this disclosure.

FIG. 7 is a schematic diagram of a virtual vehicle control method according to an aspect of this disclosure.

FIG. 8 is a schematic diagram of a virtual vehicle control method according to an aspect of this disclosure.

FIG. 9 is a schematic diagram of a virtual vehicle control method according to an aspect of this disclosure.

FIG. 10 is a schematic diagram of a virtual vehicle control method according to an aspect of this disclosure.

FIG. 11 is a schematic diagram of a virtual vehicle control method according to an aspect of this disclosure.

FIG. 12 is a schematic diagram of a virtual vehicle control method according to an aspect of this disclosure.

FIG. 13 is a schematic diagram of a virtual vehicle control method according to an aspect of this disclosure.

FIG. 14 is a schematic diagram of a virtual vehicle control apparatus according to an aspect of this disclosure.

FIG. 15 is a schematic structural diagram of a electronic device according to an aspect of this disclosure.

### DETAILED DESCRIPTION

To better understand the solutions of this disclosure, the following describes the technical solutions in the aspects of this disclosure with reference to the accompanying. The described aspects are some of the aspects of this disclosure. Other aspects shall fall within the scope of this disclosure. Further, the descriptions of the terms are provided as examples and are not intended to limit the scope of the disclosure.

In the specification, claims, and accompanying drawings of this disclosure, terms “first”, “second”, and the like are intended to distinguish similar objects but do not necessarily indicate a specific order or sequence. Such used data is interchangeable where appropriate so that the aspects of this disclosure described here can be implemented in an order other than those illustrated or described here. Moreover, the terms “include”, “contain” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

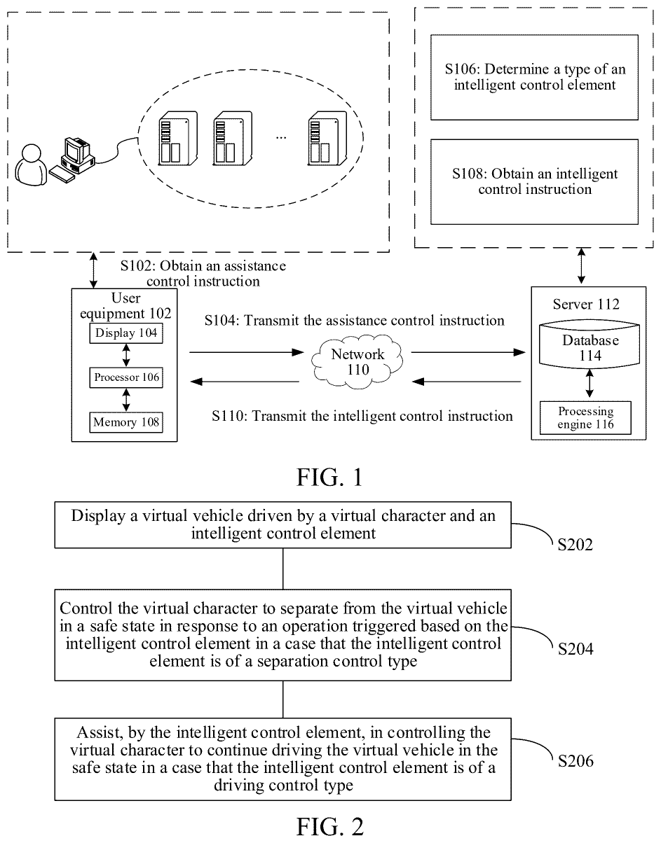

According to an aspect of an aspect of this disclosure, a virtual vehicle control method is provided. In some aspects, as an example implementation, the virtual vehicle control method may be applied, and is not limited, to an environment shown in FIG. 1. The environment may include, and is not limited to, a user equipment 102 and a server 112. The user equipment 102 may include, and is not limited to, a display 104, a processor 106, and a memory 108. The server 112 may include, and is not limited to, a database 114 and a processing engine 116.

Specific processes are as following operations.
Operation S102: The user equipment 102 obtains an assistance control instruction triggered for an intelligent control element.
Operation S104: Transmit the assistance control instruction to the server 112 via a network 110.
Operation S106 to operation S108: The server 112 responds to the assistance control instruction by using the processing engine 116, determines a type of the intelligent control element from the database 114, and further obtains an intelligent control instruction that assists in controlling a virtual character to separate from a virtual vehicle in a safe state, or an intelligent control instruction that assists in controlling the virtual character to continue driving the virtual vehicle in the safe state.
Operation S110: Transmit the intelligent control instruction to the user equipment 102 via the network 110. The user equipment 102 responds to the intelligent control instruction by using the processor 106, controls the virtual character to separate from the virtual vehicle in the safe state or assists in controlling the virtual character to continue driving the virtual vehicle in the safe state, displays a control result on the display 104, and stores the intelligent control instruction in the memory 108.

In addition to the example shown in FIG. 1, the foregoing terminal device may be a terminal device configured with a target client, and may include, and is not limited to, at least one of the following: a mobile phone (e.g., an Android mobile phone or an iOS mobile phone), a notebook computer, a tablet computer, a palmtop computer, a mobile Internet device (MID), a PAD, a desktop computer, a smart television, or the like. The target client may be a game client, a video client, an instant messaging client, a browser client, an educational client, or the like. The foregoing network may include, and is not limited to, a wired network and a wireless network. The wired network includes a local area network, a metropolitan area network, and a wide area network. The wireless network includes Bluetooth, Wi-Fi, and other networks implementing wireless communication. The foregoing server may be one server, a server cluster formed by a plurality of servers, or a cloud server. The foregoing description is merely an example. This is not limited in any way in this aspect.

In some aspects, as an example implementation, as shown in FIG. 2, the virtual vehicle control method may be performed by an electronic device. The electronic device may be, for example, the user equipment or the server shown in FIG. 1. Specific operations include:
Operation S202: Display a virtual vehicle driven by a virtual character and an intelligent control element. For example, a virtual vehicle driven by a virtual character and at least one control element is output for display.
Operation S204: Control the virtual character to separate from the virtual vehicle in a safe state in response to an operation triggered based on the intelligent control element in a case that the intelligent control element is of a separation control type. For example, an operation performed on a control element of the at least one control element is determined. Based on the operation being performed on the control element, the virtual character is controlled to separate from the virtual vehicle in a first safe state when the control element is of a separation control type.
Operation S206: Assist, by the intelligent control element, in controlling the virtual character to continue driving the virtual vehicle in the safe state in a case that the intelligent control element is of a driving control type. For example, the virtual character is controlled to continue driving the virtual vehicle in a second safe state when the control element is of a driving control type.

In this aspect, the foregoing virtual vehicle control method may be applied, and is not limited to, a game scene having a virtual motorcycle vehicle. The virtual motorcycle vehicle is a virtual vehicle having a maximum speed, a minimum volume, a maximum driving flexibility, and a maximum ornament, and is a preferred vehicle for a high-level player. A good driving technology may implement arrival at a destination within a shortest time by using the virtual motorcycle vehicle, or arrival at a place that cannot be reached by another virtual character, and occupation of a beneficial place, thereby bringing advantages to a battle of a player.

However, as a two-wheel vehicle, the virtual motorcycle vehicle has low stability and is prone to overturning. Especially when traveling at a high speed or passing through rough terrain, an overturning risk increases significantly. Once the vehicle is overturned, the virtual character controlled by the player may be damaged. This is disadvantageous in the game. However, according to the virtual vehicle control method in this aspect of this disclosure, an intelligent control element is introduced to improve control accuracy for the virtual motorcycle vehicle, thereby reducing the overturning risk. When a potential dangerous situation is detected, for example, the speed is excessively high or the terrain is rugged, the intelligent control element assists the player to separate from the virtual motorcycle vehicle in a safe state, to prevent the virtual character from being injured.

Secondly, after driving over a ramp and being in mid-air, the virtual motorcycle vehicle is prone to overturning when landing. This is because the change of a contact surface may cause the virtual motorcycle vehicle to lose balance during an instant of landing. The intelligent control element in the virtual vehicle control method in this aspect of this disclosure may also play a role in this case. When the virtual motorcycle vehicle is in mid-air, a leap trajectory and terrain of a landing point may be analyzed, and suggested operation guidance is provided by using the intelligent control element, for example, adjusting a leap attitude or a landing speed, to assist the player in controlling the virtual character to continue driving the motorcycle vehicle in a safe state.

In addition, the virtual vehicle control method in this aspect of this disclosure may further resolve a problem that the virtual motorcycle vehicle lacks corresponding driving assistance and information prompt in a game. For example, when the player controls the virtual character to drive the virtual motorcycle vehicle and needs to stop and get off, the intelligent control element may provide a stop control function, to assist the player in controlling the virtual character to safely stop in an emergency. For another example, when the player controls the virtual character to drive the virtual motorcycle vehicle up a slope and leap onto a rooftop, the intelligent control element may provide clear information prompt, such as an optimal takeoff point, a leap trajectory, and a landing position, to reduce operation difficulty and improve a success rate.

For example, the virtual vehicle control method in this aspect of this disclosure is applied to a game scene having a virtual motorcycle vehicle, to effectively resolve problems such as low stability of the virtual motorcycle vehicle, overturning, and lack of driving assistance and information prompt. By introducing an intelligent control element, control accuracy is improved, risks are reduced, and corresponding driving assistance and an information prompt are provided, to meet an advanced requirement of a player when controlling a virtual character to drive the virtual motorcycle vehicle, thereby improving control accuracy for the virtual motorcycle vehicle, thereby improving a utilization rate of the virtual motorcycle vehicle in a game, and improving gaming experience of a player.

In some aspects, when a player controls a virtual character to drive a virtual vehicle (e.g., a virtual automobile or a virtual motorcycle vehicle), this aspect displays the virtual vehicle and provides some intelligent control elements. These intelligent control elements are designed to assist the player in more safely and effectively controlling the virtual character and the virtual vehicle, especially when the player faces potential danger or needs a high-challenge operation.

In this aspect, the virtual character may be a virtual object controlled by the player in the game, represents an identity of the player, and may execute various actions and tasks, such as driving the vehicle, running, and jumping.

In this aspect, the virtual vehicle may be a virtual transport used by the virtual character in a virtual environment, such as a game or a simulator. The virtual transport is, for example, an automobile, a motorcycle vehicle, an airplane, or a vessel, and is configured to quickly move or execute a particular task in a virtual world.

In this aspect, the intelligent control element may be a special element or function on a user interface (UI), uses an algorithm and preset logic to assist the player in indirectly or directly controlling the virtual character and the virtual vehicle, or may provide a real-time suggestion or warning according to a current game state, performance of the virtual vehicle, and an operation of the player, or automatically control the virtual character or the virtual vehicle.

In this aspect, controlling the virtual character to separate from or continue driving the virtual vehicle in a safe state may be understood as a function provided by the intelligent control element, which not only assists the player in controlling the virtual character as necessary, so that the player can safely separate from the virtual vehicle (e.g., jump out of the vehicle) or continue driving the vehicle in a dangerous situation (e.g., prevent overturning by using an automatic stabilization system), but also provides control reference information for the player in some cases.

In a further example, in some aspects, it is assumed that in an open-world game, a player controls a virtual character to be driving a high-speed virtual motorcycle vehicle. When the virtual motorcycle vehicle is out of control on a steep mountain road, a flashing “Emergency separation” button (intelligent control element) may appear on a game interface. After the player presses the button, the virtual character executes a safe jumping action, jumps from the virtual motorcycle vehicle, and rolls over to a safe position. Similarly, if the player encounters a small obstacle in a process of controlling the virtual character to drive, it is still possible for control. In this aspect, the speed and direction of the virtual motorcycle vehicle may be automatically controlled (by using the intelligent control element), to assist the virtual character in continuing driving safely.

In some aspects, when an intelligent control element of a separation control type is activated or selected, for example, when the intelligent control element of a separation control type is triggered to operate, this aspect may assist the player in controlling the virtual character, so that the virtual character can safely separate from the virtual vehicle that is being driven.

In a further example, in some aspects, it is assumed that in a race game, a virtual character of a player is driving a virtual racing car. However, due to excessive speed and a sharp turn ahead, the virtual racing car is about to lose control and crash into a guardrail beside a track. In this case, a striking “Emergency separation” button (intelligent control element of a separation control type) may appear on the game interface. After the player presses the button, the virtual character immediately pops up from the virtual racing car, performs a rolling action in mid-air, and finally falls safely on the lawn beside the track, thereby avoiding collision with the guardrail.

In some aspects, when an intelligent control element of a driving control type is activated or selected, for example, when the intelligent control element of a driving control type is triggered to operate, this aspect may provide assistance or direct assistance when the player controls the virtual character to drive the virtual vehicle, to assist the player in keeping controlling the virtual vehicle, so that the virtual character can continue driving in a safe state.

In a further example, in some aspects, it is assumed that in an off-road driving game, a virtual character of a player is driving a virtual off-road vehicle through a rugged mountain road. Due to the complex terrain and numerous obstacles, the player may encounter difficulties such as wheel slippage and loss of steering control. In this case, a “Stability control” button (intelligent control element of a driving control type) is displayed on the game interface. After the player activates the button, this aspect may interfere with and assist in adjusting power output, braking, and steering of the vehicle, to ensure that the virtual off-road vehicle can safely pass through this section of rough terrain.

Alternatively, in the foregoing case, the game interface displays control reference information about how to pass through the mountain road, to assist the player in controlling the virtual vehicle based on the control reference information, so that the virtual character can continue driving in a safe state.

By means of skillful introduction of the intelligent control element, this aspect can significantly enhance control precision for the virtual character when driving the virtual vehicle. This innovation not only effectively prevents potential security hazards such as overturning and destruction, but also ensures that the player can freely choose to control the virtual character to safely separate or continue driving at a critical moment. Even if a deviation or delay exists in the operation of the player, the intelligent control element can quickly adapt to and make compensation, thereby significantly reducing an accident risk caused by a human mistake. Therefore, this aspect successfully implements technology breakthrough for improving control accuracy for the virtual vehicle, and brings smoother and safer driving experience to the player.

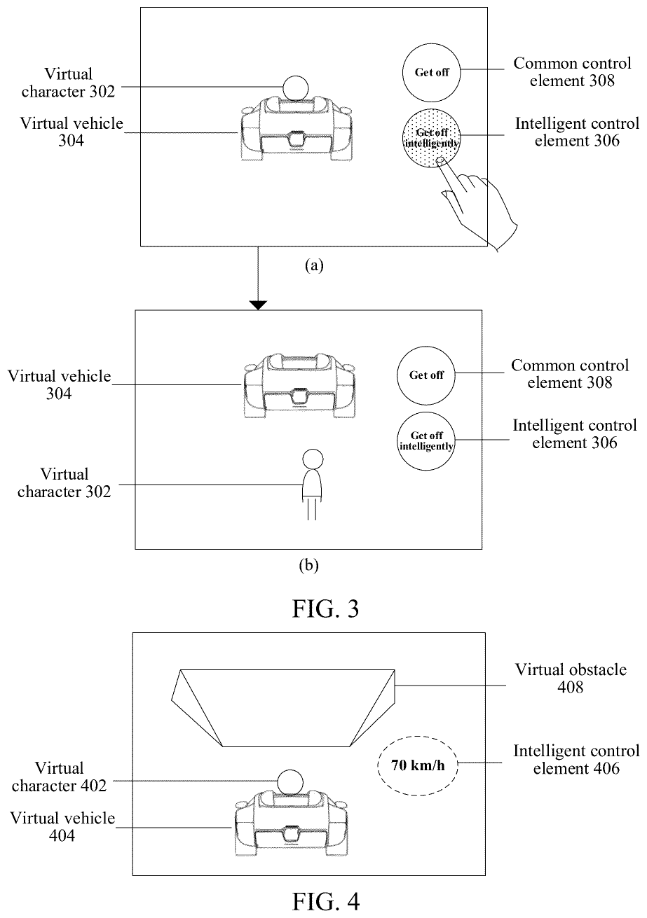

In a further example, in some aspects, as shown in (a) of FIG. 3, a virtual vehicle 304 driven by a virtual character 302 and an intelligent control element 306 of a separation control type are displayed. Meanwhile, for ease of understanding a function of the intelligent control element 306, a common control element 308 is further used as an example for displaying. Further, as shown in (b) of FIG. 3, after clicking/tapping the intelligent control element 306, a player controls the virtual character 302 to separate from the virtual vehicle 304 in a safe state.

However, after clicking/tapping the common control element 308, the player controls the virtual character 302 to directly separate from the virtual vehicle 304, but whether the virtual character 302 is in a safe state cannot be ensured, or whether the virtual character 302 is in a safe state when the player directly controls the virtual character 302 to separate from the virtual vehicle 304 cannot be learned.

In a further example, in some aspects, as shown in FIG. 4, a virtual vehicle 404 driven by a virtual character 402 and an intelligent control element 406 of a driving control type are displayed. Meanwhile, for ease of understanding a function of the intelligent control element 406, a virtual obstacle 408 is further used as an example for displaying.

Further, when a player faces the virtual obstacle 408 that is about to pass through in a process of controlling the virtual character 402 to drive the virtual vehicle 404, the player needs to precisely control the virtual character 402 to continue driving the virtual vehicle 404, so as to successfully pass through the virtual obstacle 408, but whether the virtual character 402 passes through the virtual obstacle 408 in a safe state cannot be ensured, or the player cannot learn how to control the virtual character 402 to drive the virtual vehicle 404, so as to pass through the virtual obstacle 408 in a safe state. However, in this aspect, the intelligent control element 406 is displayed to prompt the player that the virtual character 402 needs to be controlled to drive the virtual vehicle 404 at a speed of “70 km/h”, so as to successfully pass through the virtual obstacle 408. For example, in this aspect, the intelligent control element 406 may be an element for prompting, rather than an element for directly triggering control.

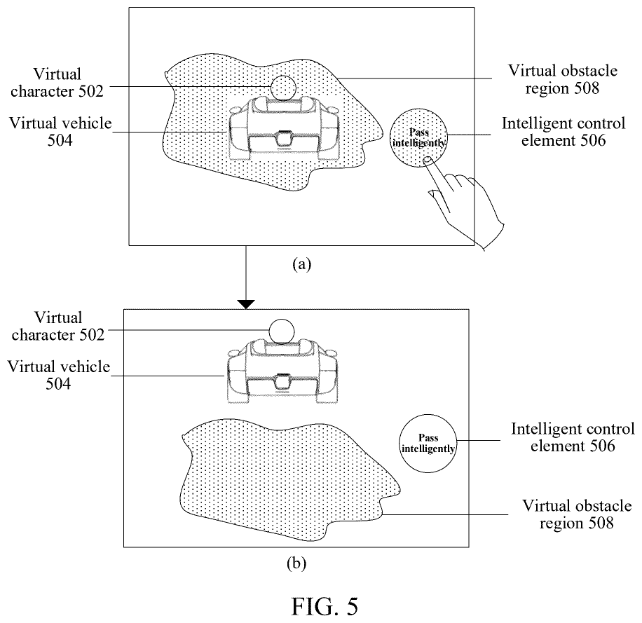

In a further example, in some aspects, as shown in (a) of FIG. 5, a virtual vehicle 504 driven by a virtual character 502 and an intelligent control element 506 of a driving control type are displayed. Meanwhile, for ease of understanding a function of the intelligent control element 506, a virtual obstacle region 508 is further used as an example for displaying. Further, when a player controls the virtual character 502 to drive the virtual vehicle 504 to travel in the virtual obstacle region 508, the player needs to precisely control the virtual character 502 to continue driving the virtual vehicle 504, so as to successfully pass through the virtual obstacle region 508, but whether the virtual character passes through the virtual obstacle region 508 in a safe state cannot be ensured. As shown in (b) of FIG. 5, after clicking/tapping the intelligent control element 506, the player may control the virtual character to pass through the virtual obstacle region 508 in a safe state.

However, if the player voluntarily controls, by means of operation experience, the virtual character 502 to drive the virtual vehicle 504 to pass through the virtual obstacle region 508, whether the virtual character 502 is in a safe state cannot be ensured, or the player cannot learn whether the virtual character 502 can successfully pass through the virtual obstacle region 508 in a safe state when voluntarily controlling the virtual character 502 to drive the virtual vehicle 504 to pass through the virtual obstacle region 508.

According to this aspect provided in this disclosure, a virtual vehicle driven by a virtual character and an intelligent control element are displayed. The virtual character is controlled to separate from the virtual vehicle in a safe state in response to an operation triggered based on the intelligent control element in a case that the intelligent control element is of a separation control type. The intelligent control element assists in controlling the virtual character to continue driving the virtual vehicle in the safe state in a case that the intelligent control element is of a driving control type. An intelligent control element is introduced to assist in controlling a relationship between a virtual character and a virtual vehicle, to improve control accuracy for the virtual character driving the virtual vehicle, thereby avoiding safety accidents such as overturning and destruction. In addition, the virtual character can safely separate from or continue driving the virtual vehicle as necessary, so that even if an operation of a player is not accurate or timely enough, the intelligent control element can be adapted and compensated to some extent, thereby reducing accident risks caused by control errors, and achieving a technical effect of improving the control accuracy for the virtual vehicle.

As an example solution, the displaying a virtual vehicle driven by a virtual character and an intelligent control element includes:
displaying the virtual vehicle driven by the virtual character and at least one intelligent control, a quantity of the at least one intelligent control being related to a state of the virtual vehicle, and the intelligent control being an intelligent control element of the separation control type.

In some aspects, when a virtual vehicle driven by a virtual character is displayed, an intelligent control element is displayed in this aspect. In particular, an intelligent control related to a separation control type is displayed. The intelligent control may be understood as an expression form of the intelligent control element, is dynamically changed according to a current state of the virtual vehicle, and is intended to assist a player in controlling the virtual character to safely separate from the virtual vehicle as necessary.

In this aspect, the intelligent control related to the state of the virtual vehicle is displayed, to provide a more intuitive and timely operation feedback, so that the player can quickly make a correct decision by using the intelligent control at a critical moment. These intelligent controls further provide an additional security guarantee, so that the player can maintain a particular control capability even when the player is not familiar with a game operation or faces an emergency.

According to this aspect provided in this disclosure, the virtual vehicle driven by the virtual character and at least one intelligent control are displayed. A quantity of the at least one intelligent control is related to a state of the virtual vehicle, and the intelligent control is an intelligent control element of the separation control type. The game provides a more intuitive and timely operation feedback, so that the player can quickly make a correct decision by using the intelligent control at a critical moment, thereby achieving a technical effect of improving control accuracy for the virtual vehicle.

As an example solution, the displaying the virtual vehicle driven by the virtual character and at least one intelligent control includes:
S-1: Display the virtual vehicle driven by the virtual character and a first intelligent control in a case that the state of the virtual vehicle is a safe state, the at least one intelligent control including the first intelligent control.
S-2: Display the virtual vehicle driven by the virtual character, the first intelligent control, and a second intelligent control in a case that the state of the virtual vehicle is a dangerous state, a first distance between the second intelligent control and an operation control of the virtual vehicle being less than a second distance between the first intelligent control and the operation control, and the at least one intelligent control including the first intelligent control and the second intelligent control.

In some aspects, when the virtual character drives the virtual vehicle, the quantity and positions of the intelligent controls displayed in this aspect may vary according to the state (safe or dangerous) of the virtual vehicle.

In this aspect, the safe state may refer to a state in which the virtual vehicle is being driven normally and does not encounter an emergency.

In this aspect, the dangerous state may refer to a state in which the virtual vehicle encounters an emergency (e.g., collision or out of control) that may cause an accident or damage.

In this aspect, the first intelligent control may be displayed when the virtual vehicle is in the safe state, and provides a basic driving assistance function.

In this aspect, the second intelligent control may be displayed only when the virtual vehicle is in the dangerous state, and is configured for a quick driving assistance operation in an emergency.

In this aspect, the quantity and positions of the intelligent controls are dynamically adjusted according to the state of the virtual vehicle, to provide more personalized and immersive user experience. In the dangerous state, the second intelligent control is placed at an accessible position, to assist the player in responding more timely, thereby avoiding or reducing a potential accident loss. This design not only enhances playability and challenge of the game, but also assists in culturing a straining capability and a decision-making capability of the player in an emergency.

According to this aspect provided in this disclosure, in a case that a virtual vehicle is in a safe state, the virtual vehicle driven by a virtual character and a first intelligent control are displayed. In a case that the virtual vehicle is in a dangerous state, the virtual vehicle driven by the virtual character, the first intelligent control, and a second intelligent control are displayed. The second intelligent control is closer to an operation control of the virtual vehicle than the first intelligent control, so as to assist a player in responding more timely in the dangerous state, to avoid or reduce a potential accident loss, thereby achieving a technical effect of improving control accuracy for the virtual vehicle.

As an example solution, before displaying the virtual vehicle driven by the virtual character and at least one intelligent control, the method further includes:
S2-1: Obtain a survival value of the virtual vehicle and an angle of the virtual vehicle relative to a traveling surface, traveling being prohibited when the survival value of the virtual vehicle is less than a first preset threshold, and the traveling surface being a surface on which the virtual vehicle is currently traveling.
S2-2: Determine that the state of the virtual vehicle is the dangerous state in a case that the survival value is less than a second preset threshold and/or the angle is less than a third preset threshold, the second preset threshold being greater than the first preset threshold.

In some aspects, before a related intelligent control is displayed, a series of pre-determinations and pre-settings may be performed in this aspect. These pre-determinations mainly focus on a survival value of the virtual vehicle and an angle between the virtual vehicle and the traveling surface, to evaluate a current state (safe or dangerous) of the virtual vehicle.

In this aspect, the survival value may refer to “health” degree or endurance of the virtual vehicle, and is usually represented as a value. When the value decreases to a degree (e.g., a first preset threshold), the virtual vehicle cannot continue to travel. When the value is greater than the first preset threshold and less than a second preset threshold, the virtual vehicle may be easily damaged.

In this aspect, the angle may be an angle between the virtual vehicle and a traveling surface (e.g., a ground, a water surface, or a runway). The angle may reflect whether the virtual vehicle is in a normal traveling attitude, for example, whether the virtual vehicle is tilted or flipped. In this aspect, when the angle is less than a third preset threshold, the virtual vehicle is in an abnormal traveling state, and is prone to be tilted or flipped.

By pre-determining the survival value of the virtual vehicle and the angle between the virtual vehicle and the traveling surface, this aspect can more accurately recognize when the virtual vehicle is in a dangerous state, and display the corresponding intelligent control on the interface in time. This not only enhances sense of reality and immersion and improves experience of the player, but also can provide assistance and feedback to the player in time at a critical moment. Meanwhile, this design also assists in culturing a straining capability and a decision-making capability of the player in an emergency.

According to this aspect provided in this disclosure, a survival value of a virtual vehicle and an angle of the virtual vehicle relative to a traveling surface are obtained. In a case that the survival value is less than a second preset threshold and/or the angle is less than a third preset threshold, it is determined that the state of the virtual vehicle is a dangerous state, so as to more accurately identify when the virtual vehicle is in the dangerous state and to display a corresponding intelligent control on an interface in time, thereby achieving a technical effect of improving control accuracy for the virtual vehicle.

As an example solution, the controlling the virtual character to separate from the virtual vehicle in a safe state in response to an operation triggered based on the intelligent control element includes:
S3-1: Adjust the state of the virtual vehicle to the safe state in response to an operation triggered for any one intelligent control of the at least one intelligent control.
S3-2: Control the virtual character to move from a driving position of the virtual vehicle to a non-driving position of the virtual vehicle.
S3-3: Control the virtual character to separate from the virtual vehicle from the non-driving position.

In some aspects, when the player triggers any one intelligent control of the at least one intelligent control, the virtual character is controlled by using the intelligent control, to separate from the virtual vehicle in a safe state in this aspect. This process includes adjusting the state of the virtual vehicle, moving the virtual character, and separating the virtual character from the vehicle finally.

In this aspect, the operation triggered on the intelligent control may be clicking/tapping, touching, or another form of interactive action performed by the player for the intelligent control.

In this aspect, the driving position may refer to a position of the virtual character when driving the virtual vehicle. The non-driving position may refer to another position on the virtual vehicle other than the driving position, and is usually configured for temporarily placing the virtual character before the virtual character separates from the virtual vehicle.

With the assistance of the intelligent control, in this aspect, when the player triggers the intelligent control, the player can quickly and accurately adjust the state of the virtual vehicle, and control the virtual character to safely separate from the virtual vehicle. This not only improves playability and smoothness of the game, but also provides the player with an emergency escape mechanism that is more intuitive and easy to operate. Meanwhile, this design also assists in culturing a rapid response and a decision-making capability of the player in an emergency.

According to this aspect provided in this disclosure, the state of a virtual vehicle is adjusted to a safe state in response to an operation triggered for any one intelligent control of at least one intelligent control. A virtual character is controlled to move from a driving position on the virtual vehicle in the safe state to a non-driving position on the virtual vehicle. Then, the virtual character is controlled to separate from the virtual vehicle from the non-driving position, so that when a player triggers the intelligent control, the state of the virtual vehicle is quickly and accurately adjusted, and the virtual character is controlled to safely separate from the virtual vehicle, thereby achieving a technical effect of improving control accuracy for the virtual vehicle.

As an example solution, the displaying a virtual vehicle driven by a virtual character and an intelligent control element includes:
S4-1: Display a mid-air virtual vehicle driven by the virtual character, a vertical distance between the mid-air virtual vehicle and any surface being greater than a fourth threshold, and the mid-air virtual vehicle and the surface not intersecting with each other.
S4-2: Display an intelligent landing control, the intelligent landing control being configured to assist in controlling the virtual character to continue driving the mid-air virtual vehicle in the safe state, and the intelligent landing control being an intelligent control element of the driving control type.

In this aspect, the mid-air state may refer to a state in which the virtual vehicle completely leaves the ground or another traveling surface and is in mid-air.

In this aspect, the intelligent landing control may be understood as a UI element, for assisting the player in controlling the virtual character to safely continue driving, or enabling the mid-air virtual vehicle to land.

By displaying the mid-air virtual vehicle and the intelligent landing control, this aspect provides an intuitive and operable manner for the player, to control the virtual character to continue driving the virtual vehicle, or to enable the virtual vehicle to safely land. This not only enhances playability and sense of reality of the game, but also improves gaming experience of the player, because the player can obtain timely assistance and feedback at a critical moment. Meanwhile, this design also assists in culturing a straining capability and a decision-making capability of the player in an emergency.

According to this aspect provided in this disclosure, a mid-air virtual vehicle driven by a virtual character is displayed, and an intelligent landing control is displayed. The intelligent landing control is configured to control the virtual character to continue driving the mid-air virtual vehicle in a safe state, so as to provide an intuitive and operable manner for a player to control the virtual character to continue driving the virtual vehicle, or to enable the virtual vehicle to land safely, thereby achieving a technical effect of improving control accuracy for the virtual vehicle.

As an example solution, the assisting, by the intelligent control element, in controlling the virtual character to continue driving the virtual vehicle in the safe state includes:
S5-1: Obtain an estimated angle between the mid-air virtual vehicle and an intended landing surface in response to an operation triggered for the intelligent landing control, the intended landing surface being an estimated landing surface of the mid-air virtual vehicle.
S5-2: Adjust a current traveling attitude of the mid-air virtual vehicle in a case that the estimated angle is greater than a first preset angle, until the estimated angle is less than the first preset angle.

In some aspects, the process of assisting, by the intelligent landing control, the player to control the virtual character to safely continue driving the mid-air virtual vehicle includes: responding to a trigger operation of the player, obtaining an estimated angle between the virtual vehicle and the intended landing surface, and adjusting a traveling attitude of the virtual vehicle according to the angle.

In this aspect, the operation triggered for the intelligent landing control may be clicking/tapping, touching, or another interactive action performed by the player for the intelligent landing control.

In this aspect, the estimated angle may be an angle that may be formed between the virtual vehicle and the intended landing surface when the virtual vehicle is intended to land.

In this aspect, the intended landing surface may be a surface on which the virtual vehicle is intended to land, such as a ground, a water surface, or a platform.

In this aspect, the first preset angle may be a safety angle standard. When the estimated angle is greater than the angle, a landing attitude of the virtual vehicle is adjusted. Otherwise, the virtual vehicle may be in a dangerous state during landing.

With the assistance of the intelligent landing control, in this aspect, the landing attitude of the virtual vehicle can be automatically evaluated and adjusted after the player triggers the intelligent landing control, to ensure that the virtual vehicle continues being driven and lands safely. This not only improves playability and smoothness of the game, but also provides the player with a landing assistance mechanism that is more intuitive and easy to operate. Meanwhile, this design also assists in culturing attention and a decision-making capability of the player in the process of controlling the landing of the virtual vehicle.

According to this aspect provided in this disclosure, in response to an operation triggered for an intelligent landing control, an estimated angle between a mid-air virtual vehicle and an intended landing surface is obtained. When the estimated angle is greater than a first preset angle, the mid-air virtual vehicle is controlled to adjust a current traveling attitude until the estimated angle is less than the first preset angle, so that a game automatically evaluates and adjusts a landing attitude of the virtual vehicle after a player triggers the intelligent landing control, to ensure that the virtual vehicle continues being driven and lands safely, thereby achieving a technical effect of improving control accuracy for the virtual vehicle.

As an example solution, the displaying a virtual vehicle driven by a virtual character and an intelligent control element includes:
S6-1: Display a mid-air virtual vehicle driven by the virtual character, a vertical distance between the mid-air virtual vehicle and any surface being greater than a fourth threshold, and the mid-air virtual vehicle and the surface not intersecting with each other.
S6-2: Display a vehicle angle identifier, the vehicle angle identifier being configured for assisting in controlling the virtual character to continue driving the mid-air virtual vehicle in the safe state, the vehicle angle identifier being configured for representing an estimated angle between the mid-air virtual vehicle and an intended landing surface, the intended landing surface being an estimated landing surface of the mid-air virtual vehicle, and the vehicle angle identifier being an intelligent control element of the driving control type.

In this aspect, content presented in a virtual environment, and especially, an intelligent control element and a function thereof displayed when the virtual vehicle driven by the virtual character is in mid-air may assist the player in controlling safe driving of the virtual vehicle by means of a visual prompt.

In this aspect, the vehicle angle identifier may be a visual element or an indicator, for presenting, to the player, an angle between the mid-air virtual vehicle and a surface on which the virtual vehicle is intended to land. This angle is crucial to safe landing.

Furthermore, in addition to the vehicle angle identifier, this aspect may further provide another type of driving control element, such as a speed indicator, an altimeter, and a heading indicator, which may assist the player in better mastering the state of the virtual vehicle and perform corresponding control.

The mid-air virtual vehicle and the vehicle angle identifier related thereto are displayed. This aspect provides an intuitive visual feedback for the player, so that the player can understand a current leap state of the virtual vehicle and a relationship between the virtual vehicle and the intended landing surface more easily. This not only enhances immersion and reality of the game, but also assists in improving gaming experience of the player, because the player may make a more accurate control decision according to these visual prompts, so as to more safely control the virtual character to drive the vehicle. Meanwhile, this design also assists in culturing space awareness and leap control capabilities of the player in a complex leap situation.

According to this aspect provided in this disclosure, a mid-air virtual vehicle driven by a virtual character is displayed, and a vehicle angle identifier is displayed. The vehicle angle identifier is configured for representing an estimated angle between the mid-air virtual vehicle and an intended landing surface. In this way, a player is provided with an intuitive visual feedback, so that the player can understand a current leap state of the virtual vehicle and a relationship between the virtual vehicle and the intended landing surface more easily, thereby achieving a technical effect of improving control accuracy for the virtual vehicle.

As an example solution, the displaying a vehicle angle identifier includes:
S7-1: Display a first angle identifier in a case that the estimated angle is less than a second preset angle, the first angle identifier being configured for indicating that landing of the mid-air virtual vehicle with a current traveling attitude is safe.
S7-2: Display a second angle identifier in a case that the estimated angle is greater than or equal to the second preset angle and is less than or equal to a third preset angle, the second angle identifier being configured for indicating that landing of the mid-air virtual vehicle with the current traveling attitude carries a risk.
S7-3: Display a third angle identifier in a case that the estimated angle is greater than the third preset angle, the third angle identifier being configured for indicating that landing of the mid-air virtual vehicle with the current traveling attitude is dangerous.

In some aspects, in the virtual environment, when the virtual vehicle is in mid-air, different vehicle angle identifiers are displayed according to the estimated angle between the virtual vehicle and the intended landing surface, to remind the player of safety of a current landing attitude in this aspect.

Furthermore, in addition to displaying the vehicle angle identifier, this aspect may further provide a sound prompt or vibration feedback, to further enhance perception of the player on the safety of the landing attitude.

By displaying different vehicle angle identifiers, this aspect can provide an intuitive and instant feedback to the player, to assist the player in determining the safety of landing of the mid-air virtual vehicle in the current traveling attitude. This not only improves playability and sense of reality of the game, but also assists in culturing determining and response capabilities of the player in a complex leap situation. Meanwhile, this design also increases the challenge and feeling of tension of the game, because the player needs to make a correct control decision according to an angle identifier in a limited time.

In a further example, in some aspects, it is assumed that the player controls the virtual character to drive the mid-air virtual vehicle to land. In this aspect, different vehicle angle identifiers are displayed according to an estimated angle between the virtual vehicle and the intended landing surface.

For example, if the estimated angle is very small (less than the second preset angle, for example, 5 degrees), this aspect displays a green first angle identifier, indicating that landing of the virtual vehicle with a current traveling state is safe.

If the estimated angle is medium (greater than or equal to the second preset angle and less than or equal to the third preset angle, for example, between 5 degrees and 10 degrees), this aspect displays a yellow second angle identifier, indicating that there is a risk that the virtual vehicle lands in the current traveling state, and the player needs to pay attention.

If the estimated angle is very large (greater than the third preset angle, for example, 10 degrees), this aspect displays a red third angle identifier, indicating that landing of the virtual vehicle with the current traveling state is dangerous, and the player needs to immediately perform adjustment.

According to this aspect provided in this disclosure, a first angle identifier is displayed in a case that an estimated angle is less than a second preset angle. The first angle identifier is configured for indicating that landing of a mid-air virtual vehicle with a current traveling attitude is safe. Alternatively, a second angle identifier is displayed in a case that the estimated angle is greater than or equal to the second preset angle and is less than or equal to a third preset angle. The second angle identifier is configured for indicating that landing of the mid-air virtual vehicle with the current traveling attitude carries a risk. Alternatively, a third angle identifier is displayed in a case that in a case that the estimated angle is greater than the third preset angle. The third angle identifier is configured for indicating that landing of the mid-air virtual vehicle with the current traveling attitude is dangerous, so as to provide an intuitive and instant feedback to a player, to assist the player in determining whether landing of the mid-air virtual vehicle with the current traveling attitude is safe, thereby achieving a technical effect of improving control accuracy for the virtual vehicle.

As an example solution, the displaying a virtual vehicle driven by a virtual character and an intelligent control element includes:
S8-1: Display that the virtual character drives the virtual vehicle to travel in a leap scene, the leap scene being a virtual scene including a leap start object and a leap target object.
S8-2: Display a leap control element in a case that the virtual vehicle faces the leap start object and a distance between the virtual vehicle and the leap start object is less than a preset distance, the leap control element being an intelligent control element of the driving control type, the leap control element being configured for assisting in controlling the virtual character to continue driving the virtual vehicle in the safe state, to pass through the leap start object and to leap to the leap target object, the leap control element being further configured for prompting at least one effective speed and a current traveling speed of the virtual vehicle, and the effective speed being a speed required by the virtual vehicle to pass through the leap start object and to leap to the leap target object.

In this aspect, content presented in a virtual environment, and especially, an element to be displayed and a function thereof when the virtual character drives the virtual vehicle to travel in a specific leap scene may assist the player in controlling the virtual character to drive the virtual vehicle to safely complete a leap action.

In this aspect, the leap scene may refer to a specific virtual scene, including a leap start object and a leap target object. The virtual character needs to drive the virtual vehicle to take off from the leap start object and leap to the leap target object.

In this aspect, the leap start object and the leap target object may be two key elements in the leap scene. The leap start object is a place from which the virtual vehicle takes off, and the leap target object is a destination to which the virtual vehicle needs to reach through a leap.

In this aspect, the leap control element may be an intelligent control element of a driving control type, for assisting the player in controlling the virtual character to drive the virtual vehicle in a safe state to complete a leap action. This element may provide an effective speed related to the leap, and display a current traveling speed of the virtual vehicle. The effective speed refers to a required speed of the virtual vehicle to safely complete the leap action, namely a required speed of the virtual vehicle to successfully leap from the leap start object to the leap target object.

In this aspect, the preset distance may be a preset distance value for determining whether a distance between the virtual vehicle and the leap start object is small enough, to determine whether to display the leap control element.

By displaying the leap control element when the virtual vehicle approaches the leap start object, this aspect can provide important information about a speed required for leap to the player, and assist the player in adjusting the traveling speed of the virtual vehicle, to ensure that the virtual vehicle safely and successfully completes a leap action. This not only enhances interaction and challenge of the game, but also improves gaming experience of the player, because the player may make a more accurate control decision according to the information. Meanwhile, this design also assists in culturing determining and response capabilities of the player in a complex driving situation.

In a further example, in some aspects, a player controls a virtual character to drive a virtual racing car to travel on a track including a jumping platform (leap start object) and a landing point (leap target object) in a racing game. When the virtual racing car approaches the jumping platform and a distance to the jumping platform is less than a preset distance, a leap control element, such as a speedometer or a speed prompt icon, is displayed on a game interface. This element may prompt the player of a minimum speed for the virtual racing car to successfully jump to the landing point, and may further display a current traveling speed of the racing car.

According to this aspect provided in this disclosure, a virtual character driving a virtual vehicle in a leap scene is displayed. A leap control element is displayed in a case that the virtual vehicle faces a leap start object and a distance between the virtual vehicle and the leap start object is less than a preset distance. The leap control element is configured for prompting at least one effective speed at which the virtual character to continue driving the virtual vehicle in a safe state, to pass through the leap start object and to successfully leap to a leap target object, and a current traveling speed of the virtual vehicle, so as to provide important information about a speed required for leap to a player and assist the player in adjusting a traveling speed of the virtual vehicle, to ensure that the virtual vehicle safely and successfully completes a leap action, thereby achieving a technical effect of improving control accuracy for the virtual vehicle.

As an example solution, before displaying a leap control element, the method further includes:
S9-1: Obtain an estimated leap trajectory presented after the virtual vehicle passes through the leap start object at the current traveling speed.
S9-2: Obtain at least one leap speed when the estimated leap trajectory intersects with the leap target object, and determine the leap speed as the effective speed.

In some aspects, before the leap control element is displayed, in this aspect, a series of operations are performed to ensure that the effective speed provided to the player enables the virtual vehicle to successfully complete the leap action, namely enables the virtual vehicle to successfully leap from the leap start object to the leap target object.

In this aspect, the estimated leap trajectory may be a predicted possible leap path of the virtual vehicle after taking off from the leap start object based on a current traveling speed of the virtual vehicle and other related parameters (such as a weight and wind resistance of the vehicle).

In this aspect, the leap speed may be a speed of the virtual vehicle when the estimated leap trajectory intersects with the leap target object, namely a required speed of the virtual vehicle at the leap start object to enable the virtual vehicle to successfully leap to the leap target object. This speed is determined as an effective speed because the speed is necessary for completing the leap.

By obtaining the estimated leap trajectory and determining the effective speed, this aspect can provide more accurate and useful information for the player, to assist the player in making a more proper control decision when controlling the virtual character to drive the virtual vehicle for a leap. This not only improves playability and challenge of the game, but also enhances gaming experience of the player, because the player may adjust an operation according to the information, to complete a leap action more safely and effectively. Meanwhile, this design also assists in culturing space perception and prediction capabilities of the player in a complex driving and leap situation.

In a further example, in some aspects, it is assumed that a player controls a virtual character to drive a virtual motorcycle vehicle toward a jumping platform (leap start object), and to be intended to leap to a distant platform (leap target object) in a special-effect game of a motorcycle vehicle. When the virtual vehicle approaches the jumping platform, a game system first calculates an estimated leap trajectory according to a current traveling speed and other physical parameters of the virtual vehicle. Next, the system analyzes the estimated trajectory to find a speed at which the trajectory intersects with the platform serving as the leap target object. This speed is a minimum leap speed required for the virtual motorcycle vehicle. Finally, the leap speed is determined as an effective speed, and is displayed in a leap control element for reference and adjustment by the player.

According to this aspect provided in this disclosure, an estimated leap trajectory presented after a virtual vehicle passes through a leap start object at a current traveling speed is obtained. At least one leap speed when the estimated leap trajectory intersects with a leap target object is obtained, and the leap speed is determined as an effective speed, so as to provide more accurate and useful information for a player, to assist the player in making a more proper control decision when driving the virtual vehicle for a leap, thereby achieving a technical effect of improving control accuracy for the virtual vehicle.

As an example solution, the displaying a virtual vehicle driven by a virtual character and an intelligent control element includes:
S10-1: Display that the virtual character drives the virtual vehicle to travel in a leap scene, the leap scene being a virtual scene including a leap start object and a leap target object.
S10-2: Display an intelligent leap control in a case that the virtual vehicle faces the leap start object and a distance between the virtual vehicle and the leap start object is less than a preset distance, the intelligent leap control being an intelligent control element of the driving control type, and the intelligent leap control being configured for controlling the virtual character to continue driving the virtual vehicle in the safe state, to pass through the leap start object and to leap to the leap target object.

In some aspects, in the virtual environment, when the virtual character drives the virtual vehicle to travel in a specific leap scene, a series of interface elements and control elements are displayed in this aspect, to assist the player in controlling the virtual character to drive the virtual vehicle to complete a leap action. The intelligent leap control may be an intelligent control element, and is designed to assist the player in controlling the virtual character to safely drive the virtual vehicle in the leap scene, and ensure successful leap from the leap start object to the leap target object.

In this aspect, the leap scene may be understood as a special virtual environment, including a start point (leap start object) and an end point (leap target object) of the leap action.

In this aspect, the intelligent leap control may be understood as a UI element of a driving control type, which provides necessary control and indication according to a current state (e.g., a position, a speed, or a direction) of the virtual vehicle and characteristics of the leap scene (e.g., positions of and a distance between a leap start point and a leap target), to assist the player in controlling the virtual character to drive the virtual vehicle to complete the leap.

In this aspect, the preset distance may be understood as a fixed distance value. When the distance between the virtual vehicle and the leap start object is less than this value, the intelligent leap control is activated and displayed.

By introducing the intelligent leap control, operation experience and a success rate of the player in the leap scene are significantly improved. By providing an intuitive prompt and necessary control, this aspect assists the player in more accurately determining leap timing and speed, thereby reducing a mistake possibility. This not only makes the game more interesting and challenging, but also enables the player to pay more attention to the stimulus and the feeling of accomplishment brought by the leap. Meanwhile, this design also reflects detailed consideration of player experience in the game, and improves the overall quality of the game.

In a further example, in some aspects, in an extreme sports game, a player drives a virtual motorcycle vehicle to enter a leap scene. The leap scene includes a jumping platform (leap start object) and a landing point (leap target object). When the virtual motorcycle vehicle travels toward the jumping platform and a distance to the jumping platform is less than a particular range (preset distance), an intelligent leap control appears on a game interface. The control may be a button, which prompts the player to “Prepare to leap”, and automatically triggers a leap action when the virtual motorcycle vehicle reaches a suitable speed, or a speedometer is provided to indicate a required speed of the virtual motorcycle vehicle to the player.

According to this aspect provided in this disclosure, a virtual character driving a virtual vehicle in a leap scene is displayed. An intelligent leap control is displayed in a case that the virtual vehicle faces a leap start object and a distance between the virtual vehicle and the leap start object is less than a preset distance. The intelligent leap control is configured for controlling the virtual character to continue driving the virtual vehicle to pass through the leap start object in a safe state, and to leap to a leap target object, so as to assist a player in more accurately determining leap timing and speed, to reduce a mistake possibility, thereby achieving a technical effect of improving control accuracy for the virtual vehicle.

As an example solution, the assisting, by the intelligent control element, in controlling the virtual character to continue driving the virtual vehicle in the safe state includes:
S11-1: Obtain, in response to an operation triggered for the intelligent leap control, an estimated leap trajectory presented after the virtual vehicle passes through the leap start object at the current traveling speed.
S11-2: Control the virtual vehicle to adjust the current traveling speed in a case that the estimated leap trajectory and the leap target object do not intersect with each other, until the estimated leap trajectory and the leap target object intersect with each other.

In some aspects, when the player drives the virtual vehicle in the virtual environment to approach the leap start object, and prepares to leap, the intelligent leap control assists the player in controlling the virtual vehicle in this aspect, to ensure that the virtual vehicle completes the leap in a safe state. The safe state may refer to that the virtual vehicle can leap to the leap target object at a suitable speed and angle, and collision or another dangerous situation does not occur in the leap process.

In this aspect, the operation triggered for the intelligent leap control may refer to an operation performed by the player for the intelligent leap control, for example, clicking/tapping, touching, or pressing, to activate a leap control procedure.

In this aspect, the estimated leap trajectory may be a leap path, predicted by physical calculation, of the virtual vehicle after taking off from the leap start object based on a current traveling speed of the virtual vehicle and other related parameters (such as a mass and air resistance of the vehicle).

In this aspect, the player may be automatically prompted to adjust the traveling speed of the virtual vehicle according to a relationship between the estimated leap trajectory and the leap target object, to ensure that the leap trajectory can intersect with the leap target object, namely, successfully leap to the leap target object.

Furthermore, in addition to adjusting the speed, in this aspect, the player may further be prompted to adjust a leap angle, use Nitro to accelerate, and the like according to a situation of the estimated leap trajectory, so as to further optimize a leap effect. Meanwhile, the system may further provide a real-time preview of the leap trajectory, so that the player can learn the leap process and a situation of a landing point more intuitively.

This aspect can provide more accurate and timely leap control assistance to the player by combining the intelligent leap control and the estimated leap trajectory, to assist the player in completing a leap action more safely and effectively. This not only improves playability and challenge of the game, but also enhances gaming experience of the player, because the player may more accurately control the virtual vehicle to complete the leap according to system prompt and adjustment. Meanwhile, this design also reflects detailed consideration of player experience and humanistic design in the game.

In a further example, in some aspects, a player drives a virtual racing car to approach a jumping platform (leap start object), and prepares to leap to a distant landing point (leap target object) in a racing game. When controlling the virtual racing car to approach the jumping platform, the player may click/tap a “Prepare to leap” button (intelligent leap control) displayed on a screen. A system may calculate an estimated leap trajectory according to a current speed of the virtual racing car and other parameters. If the estimated leap trajectory does not intersect with the landing point, in this aspect, the player is prompted to accelerate or decelerate, or the speed of the virtual racing car is automatically adjusted when the player agrees, until the estimated leap trajectory intersects with the landing point, so that the virtual racing car can successfully leap to the landing point.

According to this aspect provided in this disclosure, in response to an operation triggered for an intelligent leap control, an estimated leap trajectory presented after a virtual vehicle passes through a leap start object at a current traveling speed is obtained. In a case that the estimated leap trajectory and the leap target object do not intersect with each other, the virtual vehicle is controlled to adjust the current traveling speed until the estimated leap trajectory and the leap target object intersect with each other, so as to provide a more accurate and timely leap control assistance to the player, to assist the player in completing a leap action more safely and effectively, thereby achieving a technical effect of improving control accuracy for the virtual vehicle.

As an example solution, for ease of understanding, the foregoing virtual vehicle control method is applied to a shooting game scene. In the shooting game scene, there is a virtual motorcycle vehicle. The virtual motorcycle vehicle is a virtual vehicle having a maximum speed, a minimum volume, a maximum driving flexibility, and a maximum ornament, and is a preferred vehicle for a high-level player. A good driving technology may implement arrival at a destination within a shortest time by using the virtual motorcycle vehicle, or arrival at a place that cannot be reached by others, and occupation of a beneficial place, thereby bringing incomparable advantages to a battle of a player.

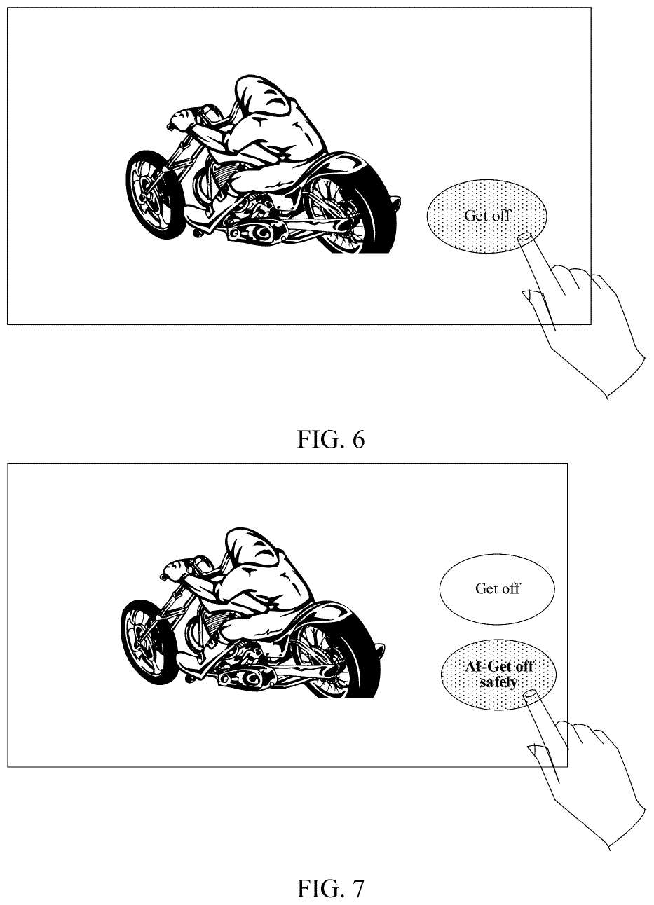

However, in a current game, a utilization rate of the virtual motorcycle vehicle consistently ranks last, primarily for the following reasons:
1. Due to the two-wheeled nature, the virtual motorcycle vehicle has poor stability, and is highly prone to overturning. Additionally, because of high speed, even if a player instructs a virtual character to get off the virtual motorcycle vehicle back to the ground, as shown in FIG. 6, a player clicks/taps a “Get off” button to exit a driving state, and the virtual character will experience momentum upon landing. If this momentum exceeds 60 km/h, a health point of the virtual character will be reduced. If the momentum exceeds 80 km/h, the virtual character will be eliminated directly.
2. In a scene that the virtual motorcycle vehicle drives over a ramp and is in mid-air before landing, the virtual motorcycle vehicle is also highly prone to overturning due to a contact surface. If this occurs during a battle, the virtual character will almost be eliminated directly.

Furthermore, there are other more advanced needs related to the virtual motorcycle vehicle that the game fails to resolve the problems adequately. For example, there is no efficient way for the player to stop and get off while controlling the virtual character to drive the virtual motorcycle vehicle. When the virtual character drives the virtual motorcycle vehicle up a slope and leaps onto a rooftop, there is no proper information prompt.

The root cause lies in the lack of safety-related information prompts in the game, which significantly increases the cost of driving the virtual motorcycle vehicle by the player. Overturning incidents frequently occur, negatively impacting battle experience and ultimately leading to extremely low usage rate of the virtual motorcycle vehicle in the game. This affects the diversity of the game. Moreover, the current safety-related operations are relatively complex. If the player desires to control the virtual character to get off safely in a case that the virtual motorcycle vehicle is in a dangerous situation, the player needs to click/tap a position-switch button in the lower right corner while simultaneously using the left hand to tilt a joystick, ensuring that the virtual vehicle is at a particular angle, and then clicks/taps the “Get off” button. This process requires at least three operations involving both hands, resulting in low efficiency and potentially disrupting the player's battle plans. The complexity may lead to the virtual character being eliminated due to delayed operations. Similarly, when the virtual motorcycle vehicle is in mid-air, the player also needs to repeatedly click/tap “Lift” and “Press” buttons to adjust the angle of the virtual motorcycle vehicle until the virtual motorcycle vehicle is parallel to the ground. This process is cumbersome, imprecise, and prone to operational errors, often resulting in overturning and a diminished gaming experience.

This aspect addresses the aforementioned pain points through a comprehensive process design, incorporating safety information prompts in each situation of driving the virtual vehicle and providing quick and accurate system functions related to “AI driving”.

First, when the player controls the virtual character to drive the virtual motorcycle vehicle, a persistent button “AI-Get off safely” is added to the right side of the interface. Upon clicking/tapping this button by the player, the virtual motorcycle vehicle will be tilted to either the left or right at a particular angle, and the virtual character will automatically switch to the rear seat and get off. This mechanism ensures that no matter how fast the player controls the virtual character to get off, the health point of the virtual character remain unaffected. Additionally, in a hazardous scene such as when the health point of the virtual motorcycle vehicle is low or a current tilt angle of the virtual motorcycle vehicle is too extreme, a temporary button “AI-Get off safely” will appear above a left joystick. Clicking this button will produce the same result as described above, enabling the player to control the virtual character to get off safely.

Second, when the player drives the virtual motorcycle vehicle over special terrain such as a ramp and is in mid-air, a special UI element “Current angle between the motorcycle and the ground” is displayed at a center crosshair of the interface. Additionally, red, yellow, and green colors indicate whether the current angle is safe. After understanding this information, the player may manually click/tap “Press” or “Lift” to adjust the virtual vehicle to an appropriate angle. Alternatively, by clicking/tapping a newly added temporary button “AI-Land safely” on the right side of the interface, the system automatically adjusts the angle between the virtual motorcycle vehicle and the ground to a safe range.

Finally, when the player drives the virtual motorcycle vehicle close to a house and performs an uphill maneuver within a particular range, the system calculates in real time which regions of the ramp and the minimum speed required for the virtual motorcycle vehicle to leap onto the rooftop. Clear information prompts are provided for the player. Throughout this procedure, not only is safety-related information supplemented, but a convenient and precise “AI Safety” button is also provided. This allows the player to enjoy hands-free operation, enhancing the gaming experience while lowering the barrier to using the virtual motorcycle vehicle and increasing the competitiveness of the game.

In this aspect, with the core objective of “enabling the player to drive the virtual motorcycle vehicle more conveniently and safely”, a permanent button “AI-Get off safely” is added to the right side of the interface during control of the virtual character to drive the virtual motorcycle vehicle, and a temporary button “AI-Get off safely” is also added above the left joystick on the interface when facing a hazardous special state. When the virtual motorcycle vehicle is in mid-air, an “angle” is displayed at the crosshair, along with a temporary button “AI-Land safely” on the right side of the interface. When the player drives the virtual motorcycle vehicle to approach a ramp near a house, a ramp model displays “speed and range” information required to reach the rooftop. In total, at least five new graphical user interface (GUI) effects are implemented to facilitate functionality and convey information.

In a further example, in some aspects, based on the scene in FIG. 6, still as shown in FIG. 7, when a player drives a virtual motorcycle vehicle to travel normally, a permanent button “AI-Get off safely” is added to the right side of an interface, and the button is displayed in a normal state by default. When the player presses the button with a finger, the button is in a clicked/tapped state. After the player lifts up the finger, a behavior of controlling the virtual character to get off safely is performed according to a particular algorithm logic, to return to a non-driving state.

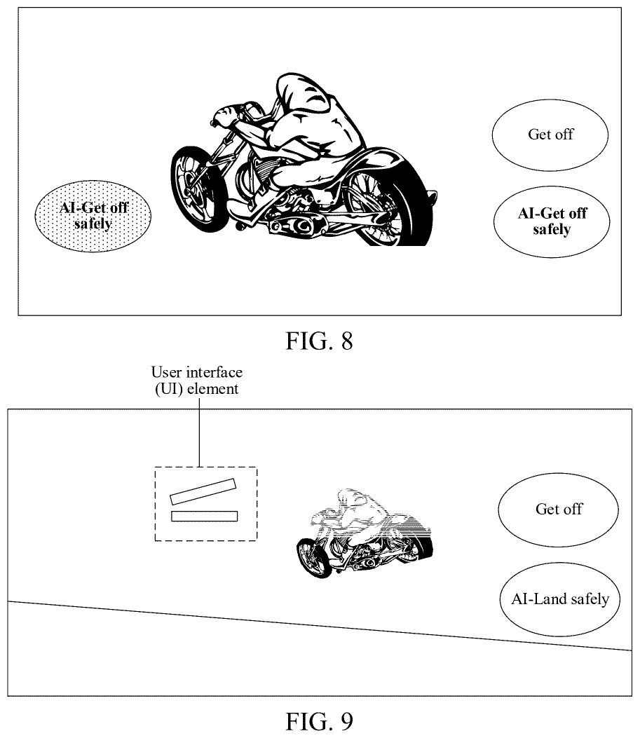

For another example, as shown in FIG. 8, when a player drives a virtual motorcycle vehicle, a health point of the virtual motorcycle vehicle is less than 40, and/or an angle between a current tilt angle of the virtual motorcycle vehicle and a ground is less than 60°, a temporary button “AI-Get off safely” is displayed on the left side of the interface, and guidance is performed by using a yellow special effect (or another color special effect, without limitation). When the player drags a finger to move to the button or presses a finger at the button, the button becomes a clicked/tapped state. After the finger is lifted, a behavior of controlling the virtual character to get off safely is performed according to a particular algorithm logic, to return to a non-driving state.

For another example, as shown in FIG. 9, when a player drives a virtual motorcycle vehicle, if a distance between the virtual motorcycle vehicle and the ground in a vertical direction reaches a preset threshold, it is determined that the virtual motorcycle vehicle is currently in a mid-air state. When the virtual motorcycle vehicle is in this state, a UI for indicating a current angle between the virtual motorcycle vehicle and the ground is displayed at a crosshair, and the UI presents different colors according to different safety situations corresponding to different angles. Meanwhile, a permanent button “AI-Land safely” is added to the right side of the interface, and a normal state is usually displayed. When the player presses the button with a finger, the button becomes a selected state. When the player loosens the finger, the virtual motorcycle vehicle performs a behavior of adjusting an angle according to a particular algorithm logic, until the virtual motorcycle vehicle lands to the ground.

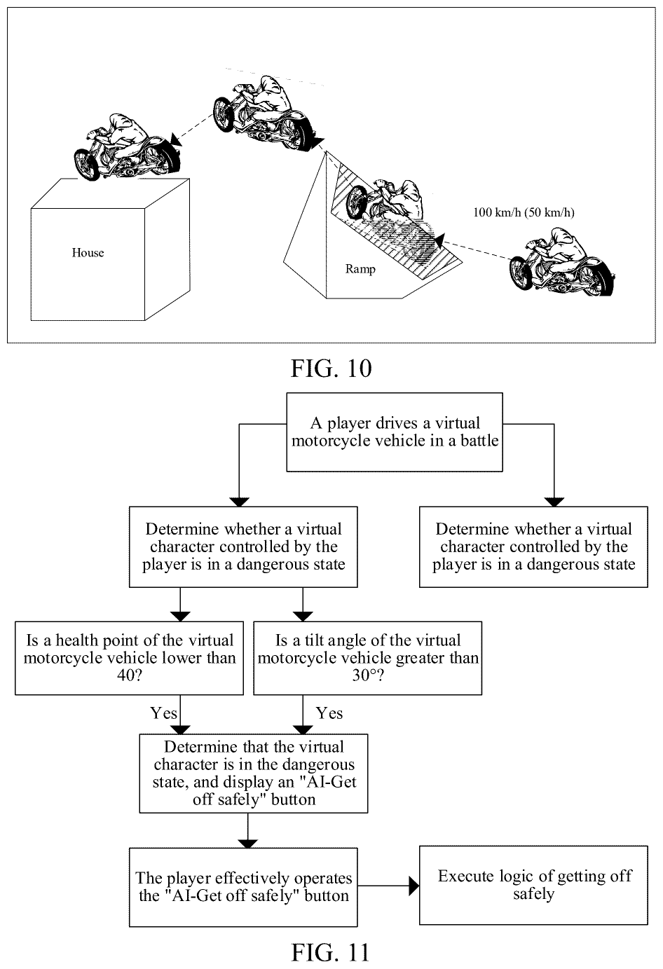

For another example, as shown in FIG. 10, when a player drives a virtual motorcycle vehicle and approaches a ramp within a particular range of a virtual building (house), whether the virtual motorcycle vehicle can leap onto the rooftop of the building when passing through the ramp is calculated according to a particular algorithm logic. If the virtual motorcycle vehicle can leap onto the rooftop, a region on the rooftop that can be reached by jumping is highlighted with a flashing yellow special effect. Additionally, a minimum required speed and a current speed are displayed, such as prompting the player that the minimum required speed is 100 km/h while the current speed is 50 km/h.

In some aspects, a core function of this aspect primarily includes the following five functions: “providing an ‘AI-Get off safely’ function in a driving state”, “safe get-off algorithm logic”, “providing an ‘AI-Land safely’ function in a mid-air state”, “safe landing algorithm logic”, and “providing information prompts when leaping onto a rooftop is possible”. The first four functions are interrelated and affect each other in pairs, while the last function is relatively independent.

For example, as shown in FIG. 11, in this aspect, logic of “providing an ‘AI-Get off safely’ function in a driving state” is as follows:

When a player drives a virtual motorcycle vehicle in a battle, a button “AI-Get off safely” is permanently displayed on the right side of an interface, and whether a virtual character controlled by the player currently belongs to a “dangerous state” needs to be determined. For example, whether a health point of the virtual motorcycle vehicle is less than 40 and/or whether a tilt angle of the virtual motorcycle vehicle is greater than 30° are determined. If the virtual character is in the “dangerous state”, the button “AI-Get off safely” is displayed on the upper side of a left joystick.

In this case, whether the player presses the button “AI-Get off safely” needs to be determined in real time. If the player presses this button, the button is in a selected state, and the style becomes highlighted. Further, whether the player lifts up the finger needs to be determined. If the player lifts up the finger, safe get-off logic is executed, and the procedure ends.

In this aspect, it is assumed that the tilt angle of the virtual vehicle is greater than 15° and the virtual character gets off from the rear seat. When both conditions are satisfied, the virtual character gets off the virtual vehicle, so that no health point is reduced. Further, when the virtual character is on the virtual vehicle, whether the virtual character is currently located at a driving position or a passenger position needs to be determined. If the virtual character is located at the passenger position, the button “AI-Get off safely” is not displayed. If the virtual character is located at the driving position, whether there is another virtual character at the passenger position is determined again. If there is another virtual character, the button “AI-Get off safely” is not displayed. When the virtual character meets a condition and it is detected that the player clicks/taps “AI-Get off safely”, the virtual vehicle is first controlled to be tilted leftwards by 16°. If a current degree of tilt of the virtual vehicle is greater than 15°, no change is made. The virtual character is further controlled to switch to a passenger position, and is automatically controlled to get off the vehicle.

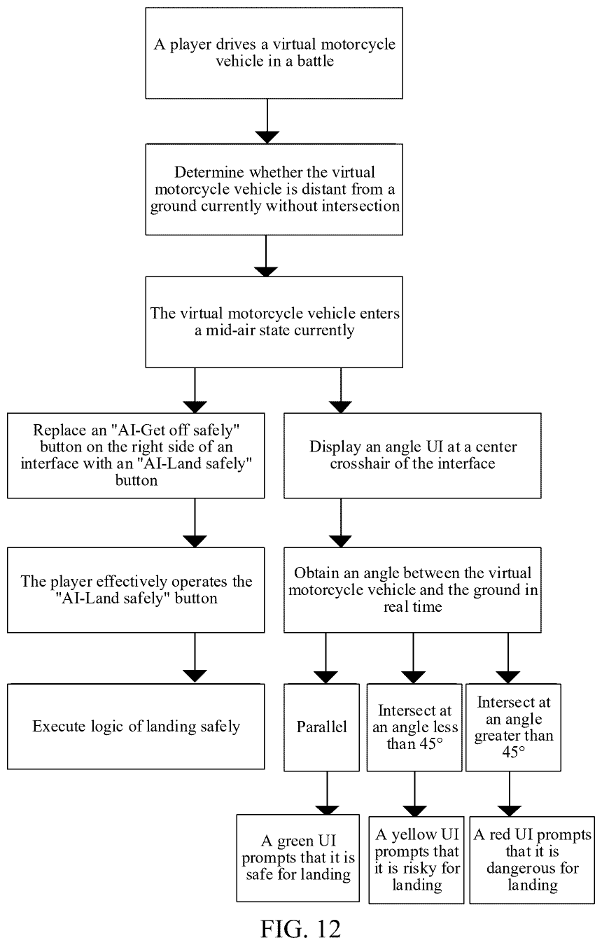

For example, as shown in FIG. 12, in this aspect, logic of “providing an ‘AI-Land safely’ function in a mid-air state” is as follows:

When a player drives a virtual motorcycle vehicle in a battle, whether the virtual motorcycle vehicle is distant from a ground currently without intersection needs to be determined in real time. If the virtual motorcycle vehicle is distant from the ground currently without intersection, it is determined that the virtual motorcycle vehicle currently enters a mid-air state.

In the mid-air state, an angle UI needs to be displayed at a center crosshair of an interface, and an angle between the virtual motorcycle vehicle and the ground needs to be determined in real time. If the virtual motorcycle vehicle and the ground are parallel, a green UI prompts that it is safe for landing. If the virtual motorcycle vehicle and the ground intersect with each other, but the angle is less than or equal to 45°, a yellow UI prompts that it is risky for landing. If the virtual motorcycle vehicle and the ground intersect with each other and the angle is greater than 45°, a red UI prompts that it is dangerous for landing.

In the mid-air state, the “AI-Get off safely” button on the right side of the interface also needs to be replaced with an “AI-Land safely” button, whether the player clicks/taps the button needs to be determined. If the player clicks/taps the button, the button enters a selected state. In the selected state, whether the player lifts up a finger needs to be determined. If the player lifts up a finger, safe landing logic is executed, and the procedure ends.

In this aspect, it is assumed that as long as an extension line of the bottom of the virtual motorcycle vehicle is parallel to an extension line of the ground, the virtual motorcycle vehicle will never overturn upon landing. When the virtual motorcycle vehicle is in mid-air and the player clicks/taps “AI-Land safely”, the system will take over control until the mid-air state ends. To quickly make the bottom of the virtual motorcycle vehicle parallel to the ground and keep this position, this aspect first identifies the terrain of the current ground and a current forward and backward tilt of the virtual motorcycle vehicle. For example, if the ground is a 15° uphill, the virtual motorcycle vehicle is parallel, without a forward and backward tilt of 15°.

Further, whether the two extension lines are consistent with being parallel is determined. If the two extension lines are not consistent with being parallel, the magnitude of an angle is determined, and it is determined how the virtual motorcycle vehicle is adjusted to achieve high speed. For example, an angle between the virtual motorcycle vehicle and the ground is also 15°, which does not conform to being parallel. The virtual motorcycle vehicle needs to be adjusted. Rotating left by 15° may align the virtual motorcycle vehicle with the ground, while rotating right may require a 345° rotation. Therefore, rotating left (i.e., “Lift” in the game) may be faster. Further, an operation is performed based on the foregoing direction and angle, and the player is automatically assisted by clicking/tapping “Lift” until the virtual motorcycle vehicle is parallel to the ground. Determining is performed continuously as long as the virtual motorcycle vehicle is still in mid-air, and the foregoing operations are repeated, to ensure that the virtual motorcycle vehicle is parallel to the ground.

In this aspect, it is assumed that a precondition of information about leaping onto the rooftop is: when the speed reaches at least 70 km/h, the virtual motorcycle vehicle performs a parabolic motion strictly according to the angle of the ramp. If a linear distance between the house and the ramp exceeds 500 m, the distance exceeds a limit distance of the parabola, and it is impossible to leap over. Such cases are directly excluded without further determining.

The calculation for 500 m is based on a maximum in-game ramp angle of 60° and a maximum speed 140 km/h of the motorcycle vehicle, resulting in a parabolic trajectory with a maximum landing point of 500 m.

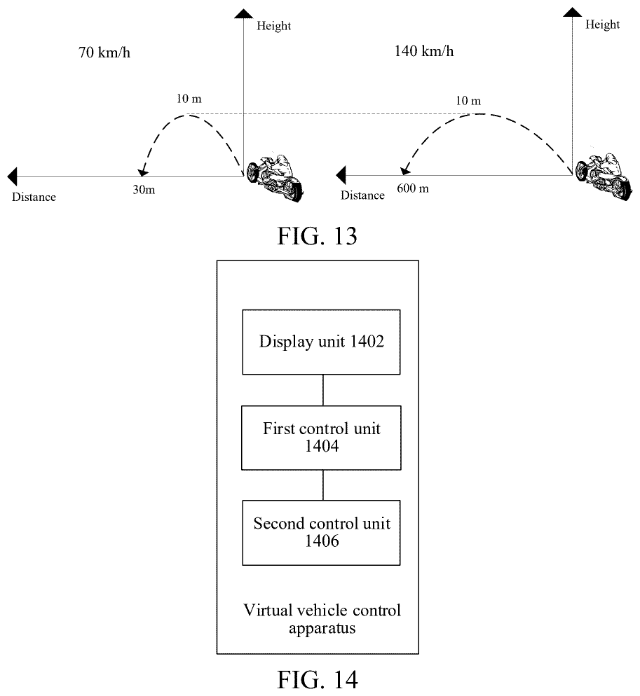

Further, whether the parabolic trajectory of the virtual motorcycle vehicle after launching off an uphill ramp can cover the rooftop is determined. If the parabolic trajectory of the virtual motorcycle vehicle after launching off the uphill ramp can cover the rooftop, the virtual motorcycle vehicle may land on the rooftop. First, the magnitude of an angle between the current uphill ramp and the ground needs to be determined. For example, an angle between an uphill ramp tilted up by 15° and the ground is 15°. Then, it is determined how a curve of the parabolic trajectory is at a particular speed above 70 km/h at the gradient. For example, as shown in FIG. 13, parabolic trajectories of the virtual motorcycle vehicle at 70 km/h and 140 km/h after launching off this uphill ramp are illustrated. Further, a house (landing object) is incorporated into the parabolic trajectory to check whether a rooftop (landing surface of the landing object) falls within a coverage region of the parabolic trajectory. For example, if a house is 10 m away from the ramp and has a height of 4 m, the conditions are met. The virtual motorcycle vehicle may launch off the ramp to reach above the rooftop and then land vertically on the rooftop by getting off. For another example, if a house is 40 m away from the ramp, regardless of the height, the conditions are not met.

Then, by applying the above algorithm to all points on the ramp, it is possible to determine which points require what speed to land on the rooftop and to calculate a minimum required speed. For example, as shown in FIG. 10, only a shaded region of the ramp meets the conditions, and the player is prompted that the minimum required speed is 100 km/h, while the current speed is 50 km/h.

According to this aspect provided in this disclosure, five safety reminders and safety functions that are added when a player drives a virtual motorcycle vehicle in a battle are used, to assist the player in better perceiving whether the virtual motorcycle vehicle is currently safe, and to assist the player in better and more conveniently performing driving control. Additionally, two AI-related functions may both assist the player in completing all operations with one click/tap, and quickly and precisely maintain a safe state, thereby further raising a game competitive ceiling, improving gaming experience, and addressing a player's pain point.

Additionally, interaction operations in an entire system are completed by means of clicking/tapping, are the simplest interaction gestures that best meet corresponding intuition, without any other complex interaction operation and understanding, thereby minimizing learning costs of a player, improving user experience, and facilitating the player to better perform operations in a game.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

To simplify the description, the foregoing method aspects are described as a series of action combination. However, it is noted that this disclosure is not limited to any described order of the actions, as some operations may be executed in another order simultaneously according to this disclosure. In addition, it is noted that the aspects described in this specification are all example aspects, and the involved actions and modules are not necessarily required to this disclosure.

According to an aspect of this disclosure, a virtual vehicle control apparatus for implementing the foregoing virtual vehicle control method is further provided. As shown in FIG. 14, the apparatus includes:

a display unit 1402, configured to display a virtual vehicle driven by a virtual character and an intelligent control element;

a first control unit 1404, configured to control the virtual character to separate from the virtual vehicle in a safe state in response to an operation triggered based on the intelligent control element in a case that the intelligent control element is of a separation control type; and

a second control unit 1406, configured to assist, by the intelligent control element, in controlling the virtual character to continue driving the virtual vehicle in the safe state in a case that the intelligent control element is of a driving control type.

For examples of specific aspects, reference can be made to the example shown in the foregoing virtual vehicle control method. Details are not described again in this example.

As an example solution, the display unit 1402 includes:
a first display module, configured to display the virtual vehicle driven by the virtual character and at least one intelligent control, a quantity of the at least one intelligent control being related to a state of the virtual vehicle, and the intelligent control being an intelligent control element of the separation control type.

For examples of specific aspects, reference can be made to the example shown in the foregoing virtual vehicle control method. Details are not described again in this example.

As an example solution, the first display module includes:
a first display submodule, configured to display the virtual vehicle driven by the virtual character and a first intelligent control in a case that the state of the virtual vehicle is a safe state, the at least one intelligent control including the first intelligent control; and
a second display submodule, configured to display the virtual vehicle driven by the virtual character, the first intelligent control, and a second intelligent control in a case that the state of the virtual vehicle is a dangerous state, a first distance between the second intelligent control and an operation control of the virtual vehicle being less than a second distance between the first intelligent control and the operation control, and the at least one intelligent control including the first intelligent control and the second intelligent control.

For examples of specific aspects, reference can be made to the example shown in the foregoing virtual vehicle control method. Details are not described again in this example.

As an example solution, the apparatus further includes:
an obtaining submodule, configured to obtain a survival value of the virtual vehicle and an angle of the virtual vehicle relative to a traveling surface before displaying the virtual vehicle driven by the virtual character and at least one intelligent control, traveling being prohibited when the survival value of the virtual vehicle is less than a first preset threshold, and the traveling surface being a surface on which the virtual vehicle is currently traveling; and
a determining submodule, configured to determine that the state of the virtual vehicle is the dangerous state in a case that the survival value is less than a second preset threshold and/or the angle is less than a third preset threshold before displaying the virtual vehicle driven by the virtual character and at least one intelligent control, the second preset threshold being greater than the first preset threshold.

For examples of specific aspects, reference can be made to the example shown in the foregoing virtual vehicle control method. Details are not described again in this example.

As an example solution, the first control unit 1404 includes:
a first adjustment module, configured to adjust the state of the virtual vehicle to the safe state in response to an operation triggered for any one intelligent control of the at least one intelligent control;
a first control module, configured to control the virtual character to move from a driving position of the virtual vehicle to a non-driving position of the virtual vehicle; and
a second control module, configured to control the virtual character to separate from the virtual vehicle from the non-driving position.

For examples of specific aspects, reference can be made to the example shown in the foregoing virtual vehicle control method. Details are not described again in this example.

As an example solution, the display unit 1402 includes:
a second display module, configured to display a mid-air virtual vehicle driven by the virtual character, a vertical distance between the mid-air virtual vehicle and any surface being greater than a fourth threshold, and the mid-air virtual vehicle and the surface not intersecting with each other; and
a third display module, configured to display an intelligent landing control, the intelligent landing control being configured to assist in controlling the virtual character to continue driving the mid-air virtual vehicle in the safe state, and the intelligent landing control being an intelligent control element of the driving control type.

For examples of specific aspects, reference can be made to the example shown in the foregoing virtual vehicle control method. Details are not described again in this example.

As an example solution, the second control unit 1406 includes:
a first obtaining module, configured to obtain an estimated angle between the mid-air virtual vehicle and an intended landing surface in response to an operation triggered for the intelligent landing control, the intended landing surface being an estimated landing surface of the mid-air virtual vehicle; and
a third control module, configured to adjust a current traveling attitude of the mid-air virtual vehicle in a case that the estimated angle is greater than a first preset angle, until the estimated angle is less than the first preset angle.

For examples of specific aspects, reference can be made to the example shown in the foregoing virtual vehicle control method. Details are not described again in this example.

As an example solution, the display unit 1402 includes:
a fourth display module, configured to display a mid-air virtual vehicle driven by the virtual character, a vertical distance between the mid-air virtual vehicle and any surface being greater than a fourth threshold, and the mid-air virtual vehicle and the surface not intersecting with each other; and
a fifth display module, configured to display a vehicle angle identifier, the vehicle angle identifier being configured for assisting in controlling the virtual character to continue driving the mid-air virtual vehicle in the safe state, the vehicle angle identifier being configured for representing an estimated angle between the mid-air virtual vehicle and an intended landing surface, the intended landing surface being an estimated landing surface of the mid-air virtual vehicle, and the vehicle angle identifier being an intelligent control element of the driving control type.

For examples of specific aspects, reference can be made to the example shown in the foregoing virtual vehicle control method. Details are not described again in this example.

As an example solution, the fifth display module includes:
a third display submodule, configured to display a first angle identifier in a case that the estimated angle is less than a second preset angle, the first angle identifier being configured for indicating that landing of the mid-air virtual vehicle with a current traveling attitude is safe; or
a fourth display submodule, configured to display a second angle identifier in a case that the estimated angle is greater than or equal to the second preset angle and is less than or equal to a third preset angle, the second angle identifier being configured for indicating that landing of the mid-air virtual vehicle with the current traveling attitude carries a risk; or
a fifth display submodule, configured to display a third angle identifier in a case that the estimated angle is greater than the third preset angle, the third angle identifier being configured for indicating that landing of the mid-air virtual vehicle with the current traveling attitude is dangerous.

For examples of specific aspects, reference can be made to the example shown in the foregoing virtual vehicle control method. Details are not described again in this example.

As an example solution, the display unit 1402 includes:
a sixth display module, configured to display that the virtual character drives the virtual vehicle to travel in a leap scene, the leap scene being a virtual scene including a leap start object and a leap target object; and
a seventh display module, configured to display a leap control element in a case that the virtual vehicle faces the leap start object and a distance between the virtual vehicle and the leap start object is less than a preset distance, the leap control element being an intelligent control element of the driving control type, the leap control element being configured for assisting in controlling the virtual character to continue driving the virtual vehicle in the safe state, to pass through the leap start object and to leap to the leap target object, the leap control element being further configured for prompting at least one effective speed and a current traveling speed of the virtual vehicle, and the effective speed being a speed required by the virtual vehicle to pass through the leap start object and to leap to the leap target object.

For examples of specific aspects, reference can be made to the example shown in the foregoing virtual vehicle control method. Details are not described again in this example.

As an example solution, the apparatus further includes:
a second obtaining module, configured to obtain, before displaying a leap control element, an estimated leap trajectory presented after the virtual vehicle passes through the leap start object at the current traveling speed; and
a third obtaining module, configured to obtain, before displaying a leap control element, at least one leap speed when the estimated leap trajectory intersects with the leap target object, and determine the leap speed as the effective speed.

For examples of specific aspects, reference can be made to the example shown in the foregoing virtual vehicle control method. Details are not described again in this example.

As an example solution, the display unit 1402 includes:
an eighth display module, configured to display that the virtual character drives the virtual vehicle to travel in a leap scene, the leap scene being a virtual scene including a leap start object and a leap target object; and
a ninth display module, configured to display an intelligent leap control in a case that the virtual vehicle faces the leap start object and a distance between the virtual vehicle and the leap start object is less than a preset distance, the intelligent leap control being an intelligent control element of the driving control type, and the intelligent leap control being configured for controlling the virtual character to continue driving the virtual vehicle in the safe state, to pass through the leap start object and to leap to the leap target object.

For examples of specific aspects, reference can be made to the example shown in the foregoing virtual vehicle control method. Details are not described again in this example.

As an example solution, the second control unit 1406 includes:
a fourth obtaining module, configured to obtain, in response to an operation triggered for the intelligent leap control, an estimated leap trajectory presented after the virtual vehicle passes through the leap start object at the current traveling speed; and
a second adjustment module, configured to control the virtual vehicle to adjust the current traveling speed in a case that the estimated leap trajectory and the leap target object do not intersect with each other, until the estimated leap trajectory and the leap target object intersect with each other.

For examples of specific aspects, reference can be made to the example shown in the foregoing virtual vehicle control method. Details are not described again in this example.

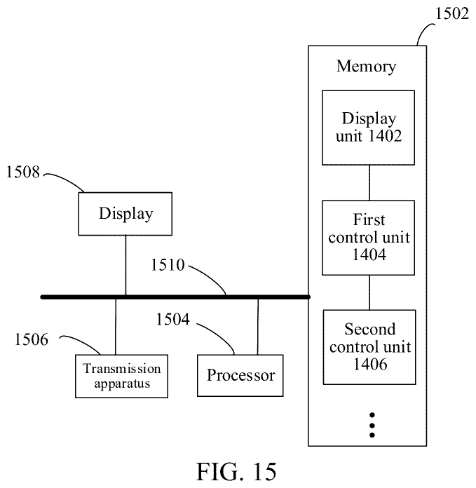

According to another aspect of this disclosure, an electronic device for implementing the foregoing virtual vehicle control method is further provided. The electronic device may be, and is not limited to, the user equipment 102 or the server 112 shown in FIG. 1. In this aspect, for example, the electronic device is the user equipment 102. Further, as shown in FIG. 15, the electronic device includes a memory 1502 (an example of non-transitory computer-readable storage medium) and a processor 1504 (an example of processing circuitry). The memory 1502 has a computer program stored therein. The processor 1504 is configured to perform the operations in any one of the foregoing method aspects by using the computer program.

In this aspect, the electronic device may be located in at least one network device of a plurality of network devices in a computer network.

In this aspect, the processor may be configured to perform the operations in the foregoing virtual vehicle control method by using the computer program.

In some aspects, a person of ordinary skill in the art should understand that, a structure shown in FIG. 15 is only schematic, and a structure of the foregoing electronic device is not limited in FIG. 15. For example, the electronic device may further include more or fewer components (e.g., a network interface) than those shown in FIG. 15, or has a configuration different from that shown in FIG. 15.

The memory 1502 may be configured to store a software program and a module, such as a program instruction/module corresponding to the virtual vehicle control method and apparatus in aspects of this disclosure. The processor 1504 executes the software program and the module stored in the memory 1502, to perform various function applications and data processing. For example, the foregoing virtual vehicle control method is implemented. The memory 1502 may include a high-speed random memory, and may further include a non-volatile memory, such as one or more magnetic storage apparatuses, a flash memory, or another nonvolatile solid-state memory. In some aspects, the memory 1502 may further include memories remotely disposed relative to the processor 1504, and these remote memories may be connected to the electronic device through a network. Examples of the network include, and are not limited to, the Internet, an Intranet, a local area network, a mobile communication network, and a combination thereof. The memory 1502 may be specifically, and is not limited to, configured to store information such as a virtual character, a virtual vehicle, and an intelligent control element. As an example, as shown in FIG. 15, the memory 1502 may include, and is not limited to, the display unit 1402, the first control unit 1404, and the second control unit 1406 in the foregoing virtual vehicle control apparatus. In addition, the memory may further include, and is not limited to, another module unit in the virtual vehicle control apparatus. Details are not described again in this example.

In some aspects, a transmission apparatus 1506 is configured to receive or transmit data through a network. Examples of the foregoing network may include a wired network and a wireless network. In an example, the transmission apparatus 1506 includes a network interface controller (NIC). The NIC may be connected to another network device and a router by using a network cable, so as to communicate with the Internet or a local area network. In an example, the transmission apparatus 1506 is a radio frequency (RF) module, which communicates with the Internet wirelessly.

In addition, the foregoing electronic device further includes: a display 1508 for displaying the information such as the virtual character, the virtual vehicle, and the intelligent control element; and a connection bus 1510 for connecting various module components in the electronic device.

In other aspects, the foregoing user equipment or server may be a node in a distributed system, where the distributed system may be a blockchain system. The blockchain system may be a distributed system formed by a plurality of nodes connected in the form of network communication. A peer to peer network may be formed between the nodes. Any form of a computing device, such as the server, the user equipment, and another electronic device, may become a node in the blockchain system by joining the peer-to-peer network.

According to an aspect in this disclosure, a computer program product is provided. The computer program product includes a computer program/instructions. The computer program/instructions may include program code for performing the method shown in the flowchart. In such an aspect, the computer program may be downloaded and installed from the network by using a communication part, and/or may be installed from a removable medium. When executed by a central processing unit, the computer program executes functions provided in this aspect of this disclosure.

The sequence numbers of the foregoing aspects of this disclosure are merely for description purpose and do not imply the preference among the aspects.

A computer system of the electronic device is merely an example, and does not constitute any limitation on functions and use scopes of this aspect of this disclosure.

The computer system includes a central processing unit (CPU), which may perform various suitable actions and processing according to a program stored in a read-only memory (ROM) or a program loaded from a storage part into a random access memory (RAM). The random access memory further stores various programs and data required for system operations. The central processing unit, the read-only memory, and the random access memory are connected to each other through a bus. An input/output (I/O) interface is also connected to the bus.

The following components are connected to the input/output interface: an input part including a keyboard, a mouse, or the like, an output part including a cathode ray tube (CRT), a liquid crystal display (LCD), a speaker, or the like, a storage part including a hard disk, or the like, and a communication part including a network interface card such as a local area network card or a modem. The communication part performs communication processing by using a network such as the Internet. A driver is also connected to the input/output interface as needed. A removable medium, such as a magnetic disk, an optical disc, a magneto-optical disk, or a semiconductor memory, is installed on the driver as required, so that a computer program read from the removable medium is installed into the storage part as required.

Particularly, according to this aspect of this disclosure, the processes described in the method flowcharts may be implemented as computer software programs. For example, an aspect of this disclosure provides a computer program product, which includes a computer program carried on a computer-readable medium. The computer program includes program code for performing the method shown in the flowchart. In such an aspect, the computer program may be downloaded and installed from the network by using a communication part, and/or may be installed from a removable medium. When the computer program is executed by the central processing unit, the various functions defined in the system of this disclosure are executed.

According to an aspect of this disclosure, a computer-readable storage medium, such as a non-transitory computer-readable storage medium, is provided. A processor of a computer device reads computer instructions from the computer-readable storage medium, and the processor executes the computer instructions, so that the computer device performs the method provided in the foregoing various example implementations.

In this aspect, the computer-readable storage medium may be configured to store a computer program for performing the operations in the foregoing virtual vehicle control method.

In this aspect of this disclosure, a term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

In this aspect, a person of ordinary skill in the art should understand that all or some of the operations of various methods in the foregoing aspects may be implemented by a program instructing relevant hardware of a terminal device. The program may be stored in a computer-readable storage medium. The storage medium may include: a flash drive, a read-only memory (ROM), a random access memory (RAM), a magnetic disk, an optical disc, or the like.

The sequence numbers of the foregoing aspects of this disclosure are merely for description purpose and do not imply the preference among the aspects.

When an integrated unit in the foregoing aspects is implemented in the form of a software functional unit and sold or used as an independent product, the integrated unit may be stored in the foregoing computer-readable storage medium. Based on such an understanding, the technical solutions of this disclosure essentially, or a part contributing to the related art, or all or a part of the technical solution may be implemented in a form of a software product. The computer software product is stored in a storage medium and includes several instructions for instructing one or more computer devices (which may be a personal computer, a server, a network device or the like) to perform all or some of the operations of the method in the aspects of this disclosure.

In the foregoing aspects of this disclosure, the descriptions of the aspects have respective focuses. For a part that is not described in detail in an aspect, refer to related descriptions in other aspects.

In the several aspects provided in this disclosure, the disclosed user equipment may be implemented in another manner. The foregoing described apparatus aspects are merely examples. For example, the unit division is merely logical function division and there may be other division manners in other implementations. For example, a plurality of units or components may be combined or integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

The units described as separate parts may or may not be physically separate, and components displayed as units may or may not be physical units, that is, may be located in one position, or may be distributed on a plurality of network units. Some or all of the units may be selected according to actual needs to achieve the objectives of the solutions of the aspects.

In addition, functional units in the aspects of this disclosure may be integrated into one processing unit, or each of the units may be physically separated, or two or more units may be integrated into one unit. The integrated unit may be implemented in the form of hardware, or may be implemented in the form of a software functional unit.

The foregoing descriptions are merely example implementations of this disclosure. A person of ordinary skill in the art may further make several improvements and modifications without departing from the principle of this disclosure, and the improvements and modifications fall within the scope of this disclosure.

What is claimed is:

1. A virtual vehicle control method, comprising:
outputting for display a virtual vehicle driven by a virtual character and at least one control element;
determining an operation is performed on a control element of the at least one control element; and
based on the operation being performed on the control element,
controlling the virtual character to separate from the virtual vehicle in a first safe state when the control element is of a separation control type; and
controlling the virtual character to continue driving the virtual vehicle in a second safe state when the control element is of a driving control type.

2. The method according to claim 1, wherein the outputting for display the virtual vehicle comprises:
outputting for display the virtual vehicle driven by the virtual character and the at least one control element, a quantity of the at least one control element being related to a state of the virtual vehicle, and the control element being of the separation control type.

3. The method according to claim 2, wherein the outputting for display the virtual vehicle comprises:
outputting for display the virtual vehicle driven by the virtual character and a first control element of the at least one control element when the virtual vehicle is in a safe operating state; and
outputting for display the virtual vehicle driven by the virtual character, the first control element, and a second control element of the at least one control element when the virtual vehicle is in a predefined state, a distance between the second control element and an operation control element of the virtual vehicle being less than a distance between the first control element and the operation control element.

4. The method according to claim 2, further comprising:
obtaining a survival value of the virtual vehicle and an angle of the virtual vehicle relative to a driving surface, the virtual vehicle being prohibited from travelling when the survival value is less than a first preset threshold, the driving surface being a surface on which the virtual vehicle is currently traveling; and
determining that the virtual vehicle is in a predefined state when the survival value is less than a second preset threshold or the angle is less than a third preset threshold, the second preset threshold being greater than the first preset threshold.

5. The method according to claim 2, wherein the controlling the virtual character to separate from the virtual vehicle in the first safe state comprises:
adjusting the state of the virtual vehicle to the first safe state based on the operation performed on the control element;
controlling the virtual character to move from a driving position of the virtual vehicle to a non-driving position of the virtual vehicle; and
controlling the virtual character to separate from the virtual vehicle from the non-driving position.

6. The method according to claim 1, wherein the outputting for display the virtual vehicle comprises:
outputting for display a mid-air virtual vehicle driven by the virtual character, a vertical distance between the mid-air virtual vehicle and a ground surface being greater than a fourth threshold, and the mid-air virtual vehicle and the ground surface not intersecting with each other; and
outputting for display a landing control element that is of the driving control type to enable the virtual character to continue driving the mid-air virtual vehicle in the second safe state.

7. The method according to claim 6, wherein the controlling the virtual character to continue driving the virtual vehicle in the second safe state comprises:
obtaining an estimated angle between the mid-air virtual vehicle and an intended landing surface in response to the operation performed on the landing control element, the intended landing surface being an estimated landing surface of the mid-air virtual vehicle; and
adjusting a current traveling attitude of the mid-air virtual vehicle to reduce the estimated angle below a first preset angle when the estimated angle exceeds the first preset angle.

8. The method according to claim 1, wherein the outputting for display the virtual vehicle comprises:
outputting for display a mid-air virtual vehicle driven by the virtual character, a vertical distance between the mid-air virtual vehicle and a ground surface being greater than a fourth threshold, and the mid-air virtual vehicle and the ground surface not intersecting with each other; and
outputting for display a vehicle angle identifier, the vehicle angle identifier indicating an estimated angle between the mid-air virtual vehicle and an intended landing surface, the intended landing surface being an estimated landing surface of the mid-air virtual vehicle.

9. The method according to claim 8, wherein the outputting for display the vehicle angle identifier comprises:
outputting for display a first angle identifier when the estimated angle is less than a second preset angle, the first angle identifier indicating that landing of the mid-air virtual vehicle with a current traveling attitude is safe;
outputting for display a second angle identifier when the estimated angle is greater than or equal to the second preset angle and less than or equal to a third preset angle, the second angle identifier indicating that landing of the mid-air virtual vehicle with the current traveling attitude carries a risk; and
outputting for display a third angle identifier when the estimated angle is greater than the third preset angle, the third angle identifier indicating that landing of the mid-air virtual vehicle with the current traveling attitude is dangerous.

10. The method according to claim 1, wherein the outputting for display the virtual vehicle comprises:
outputting for display the virtual character driving the virtual vehicle in a leap scene, the leap scene being a virtual scene including a leap start object and a leap target object; and
outputting for display a leap control element that is of the driving control type when the virtual vehicle faces the leap start object and a distance between the virtual vehicle and the leap start object is less than a preset distance, the leap control element being configured to enable control of the virtual character to continue driving the virtual vehicle to perform a leap and to provide information including at least one effective speed and a current traveling speed of the virtual vehicle, the effective speed being the speed required for the virtual vehicle to pass through the leap start object and to leap to the leap target object.

11. The method according to claim 10, further comprising:
obtaining an estimated leap trajectory presented after the virtual vehicle passes through the leap start object at the current traveling speed;
obtaining at least one leap speed when the estimated leap trajectory intersects with the leap target object; and
determining the leap speed as the effective speed.

12. The method according to claim 10, wherein the leap control element is configured to trigger automatic control of the virtual character to continue driving the virtual vehicle in the second safe state, to pass through the leap start object, and to leap to the leap target object.

13. The method according to claim 12, further comprising:
obtaining, in response to activation of the leap control element, an estimated leap trajectory presented after the virtual vehicle passes through the leap start object at the current traveling speed; and
controlling the virtual vehicle to adjust the current traveling speed to match the estimated leap trajectory to the leap target object.

14. A virtual vehicle control apparatus, comprising:
processing circuitry configured to:
output for display a virtual vehicle driven by a virtual character and at least one control element;
determine an operation is performed on a control element of the at least one control element; and
based on the operation being performed on the control element,
control the virtual character to separate from the virtual vehicle in a first safe state when the control element is of a separation control type; and
control the virtual character to continue driving the virtual vehicle in a second safe state when the control element is of a driving control type.

15. The apparatus according to claim 14, wherein the processing circuitry is configured to:
output for display the virtual vehicle driven by the virtual character and the at least one control element, a quantity of the at least one control element being related to a state of the virtual vehicle, and the control element being of the separation control type.

16. The apparatus according to claim 15, wherein the processing circuitry is configured to:
output for display the virtual vehicle driven by the virtual character and a first control element of the at least one control element when the virtual vehicle is in a safe operating state; and
output for display the virtual vehicle driven by the virtual character, the first control element, and a second control element of the at least one control element when the virtual vehicle is in a predefined state, a distance between the second control element and an operation control element of the virtual vehicle being less than a distance between the first control element and the operation control element.

17. The apparatus according to claim 15, wherein the processing circuitry is configured to:
obtain a survival value of the virtual vehicle and an angle of the virtual vehicle relative to a driving surface, the virtual vehicle being prohibited from travelling when the survival value is less than a first preset threshold, the driving surface being a surface on which the virtual vehicle is currently traveling; and
determine that the virtual vehicle is in a predefined state when the survival value is less than a second preset threshold or the angle is less than a third preset threshold, the second preset threshold being greater than the first preset threshold.

18. The apparatus according to claim 15, wherein the processing circuitry is configured to:
adjust the state of the virtual vehicle to the first safe state based on the operation performed on the control element;
control the virtual character to move from a driving position of the virtual vehicle to a non-driving position of the virtual vehicle; and
control the virtual character to separate from the virtual vehicle from the non-driving position.

19. The apparatus according to claim 14, wherein the processing circuitry is configured to:
output for display a mid-air virtual vehicle driven by the virtual character, a vertical distance between the mid-air virtual vehicle and a ground surface being greater than a fourth threshold, and the mid-air virtual vehicle and the ground surface not intersecting with each other; and
output for display a landing control element that is of the driving control type to enable the virtual character to continue driving the mid-air virtual vehicle in the second safe state.

20. A non-transitory computer-readable storage medium storing instructions which, when executed by a processor, cause the processor to perform:
outputting for display a virtual vehicle driven by a virtual character and at least one control element;
determining an operation is performed on a control element of the at least one control element; and
based on the operation being performed on the control element,
controlling the virtual character to separate from the virtual vehicle in a first safe state when the control element is of a separation control type; and
controlling the virtual character to continue driving the virtual vehicle in a second safe state when the control element is of a driving control type.
